(19) United States
(12) Patent Application Publication
(10) Pub. No.: US 2025/0020842 A1
(43) Pub. Date: Jan. 16, 2025

(54) DURABLE OPTICAL WINDOW FOR LIDAR APPLICATIONS

(71) Applicant: CORNING INCORPORATED, CORNING, NY (US)

(72) Inventors: Shandon Dee Hart, Elmira, NY (US); Karl William Koch, III, Elmira, NY (US); Carlo Anthony Kosik Williams, Painted Post, NY (US); Lin Lin, Painted Post, NY (US); Alexandre Michel Mayolet, Corning, NY (US); Charles Andrew Paulson, Painted Post, NY (US); James Joseph Price, Corning, NY (US)

(21) Appl. No.: 18/713,001

(22) PCT Filed: Nov. 28, 2022
(86) PCT No.: PCT/US2022/051039

§ 371 Date: May 23, 2024

Related U.S. Application Data
(60) Provisional application No. 63/409,443, filed on Sep. 23, 2022.
(60) Provisional application No. 63/284,161, filed on Nov. 30, 2021.

(51) Int. Cl. G02B 5/20; G01S 7/481; G02B 5/28

(52) U.S. Cl. CPC G02B 5/208; G01S 7/4811; G02B 5/281

(57) ABSTRACT

A window for a sensing system is provided that includes: a substrate comprising an outer and an inner primary surface; an outer layered film disposed on the outer primary surface; and an inner layered film disposed on the inner primary surface. Each of the outer and inner layered films comprises alternating high index and low index layers. The outer layered film comprises a scratch resistant layer having a thickness from about 0.5 μm to about 10 μm, and exhibits a hardness of at least 11 GPa, as measured with a Berkovich Indenter Hardness Test. The window exhibits an average transmittance of greater than 85% within ±25 nm of at least one wavelength within the infrared spectrum from 900 nm to 1600 nm and an average transmittance of less than 5% in the visible spectrum from 420 nm to 650 nm, each at an angle of incidence<15°.

### PRIORITY

This application claims the benefit of priority under 35 U.S.C. § 119 of U.S. Provisional Application Ser. No. 63/284,161 filed on Nov. 30, 2021, and 63/409,443 filed on Sep. 23, 2022, each of which is incorporated by reference herein in its entirety.

### FIELD

The present disclosure generally relates to durable windows and articles for LIDAR applications with high transmittance in the infrared spectrum and low transmittance in the visible spectrum, particularly windows with outer and inner layered films having alternating high and low refractive index layers and other features to support LIDAR-driven optical attributes.

### BACKGROUND

Light detection and ranging (“LIDAR”) systems include a laser and a sensor. The laser emits a laser beam, which may reflect off an object, and the sensor detects the reflected laser beam. The laser beams are pulsed or otherwise distributed across a radial range to detect objects across a field of view. Information about the object can be deciphered from the properties of the detected reflected laser beam. Distance of the object from the laser beam can be determined from the time of flight from emission of the laser beam to detection of the reflected laser beam. If the object is moving, path and velocity of the object can be determined from shifts in radial position of the emitted laser beam being reflected and detected as a function of time, as well as from Doppler frequency measurements.

LIDAR systems in automobiles, and other infrared sensing systems in exposed environments, such as aerospace or home security applications, need to be protected from the environment and various sources of damage, for example, with a covering lens or cover glass window. Vehicles are another potential application for LIDAR systems, with the LIDAR systems providing spatial mapping capability to enable assisted, semi-autonomous, or fully autonomous driving. In such applications, the laser emitter and sensor are mounted on the roof of the vehicle or on a low forward portion of the vehicle. Lasers emitting electromagnetic radiation having a wavelength outside the range of visible light, such as at 905 nm or 1550 nm, are considered for vehicle LIDAR applications. To protect the laser and sensor from impact from rocks and other objects, a window is placed between the laser and sensor, and the external environment in the line of sight of the laser and sensor. A window is similarly placed between the laser/sensor and the external environment for other applications of the LIDAR system, such as aerospace and home security applications. However, there is a problem in that rocks and other objects impacting the window scratch and cause other types of damage to the window, which cause the window to scatter the emitted and reflected laser beams, thus impairing the effectiveness of the LIDAR system.

LIDAR sensor performance is also known to be negatively influenced by microwave radiation present in the environment in proximity to the sensor. For example, mobile phones in proximity to the sensor can produce microwave radiation that can reduce the effectiveness of the sensor and the LIDAR system that employs it.

Further, owners of vehicles with LIDAR systems and vehicle manufacturers desire certain aesthetics associated with these systems, in addition to the functional benefits that these systems provide. For example, vehicle manufacturers may prefer that the aesthetics (e.g., color) of the windows employed in these systems be configured to match the aesthetics of other vehicular features (e.g., tinting of headlight lens covers, accent features, puddle light color, etc.). In other cases, vehicle owners may wish for the LIDAR system, including its window, to exhibit a particular, desired color, perhaps to complement the color of the body of the vehicle or to otherwise match an accent feature.

Accordingly, there is a need for durable windows and articles for LIDAR applications with high transmittance in the infrared spectrum and low transmittance in the visible spectrum, along with other attributes, including microwave shielding and/or a controllable, exhibited color.

### SUMMARY

According to an aspect of the disclosure, a window for a sensing system is provided that includes: a substrate comprising an outer primary surface and an inner primary surface, wherein the outer and inner primary surfaces are opposite of one another; an outer layered film disposed on the outer primary surface of the substrate; and an inner layered film disposed on the inner primary surface of the substrate. The outer layered film comprises a plurality of alternating high index and low index layers. The inner layered film comprises a plurality of alternating high index and low index layers. Each of the high index layers has a refractive index greater than a refractive index of each of the low index layers. The outer layered film comprises a scratch resistant layer having a thickness from about 0.5 μm to about 10 μm. The outer layered film exhibits a hardness of at least 11 GPa, as measured with a Berkovich Indenter Hardness Test from the outermost surface of the outer layered film to a depth of 1 μm. Further, the quantity, thicknesses and materials of the plurality of alternating high index and low index layers of the outer layered film and the inner layered film are configured so that the window exhibits an average transmittance of greater than 85% within ±25 nm of at least one wavelength within the infrared spectrum from 900 nm to 1600 nm at an angle of incidence<15° and an average transmittance of less than 5% in the visible spectrum from 420 nm to 650 nm at an angle of incidence<15°.

According to another aspect of the disclosure, a window for a sensing system is provided that includes: a substrate comprising an outer primary surface and an inner primary surface, wherein the outer and inner primary surfaces are opposite of one another; an outer layered film disposed on the outer primary surface of the substrate; and an inner layered film disposed on the inner primary surface of the substrate. The outer layered film comprises a plurality of alternating high index and low index layers. The inner layered film comprises a plurality of alternating high index and low index layers. Each of the high index layers has a refractive index greater than a refractive index of each of the low index layers. The outer layered film comprises a scratch resistant layer having a thickness from about 0.5 μm to about 10 μm. Further, the inner layered film comprises one or more absorption layers, wherein each absorption layer comprises a refractive index of 3.0 or greater and an extinction coefficient of 0.1 or greater at one or more wavelengths in the ultraviolet and visible spectra from 100 nm to 700 nm. The outer layered film exhibits a hardness of at least 11 GPa, as measured with a Berkovich Indenter Hardness Test from the outermost surface of the outer layered film to a depth of 1 μm. Further, the quantity, thicknesses and materials of the plurality of alternating high index and low index layers of the outer layered film and the inner layered film are configured so that the window exhibits an average transmittance of greater than 85% within ±25 nm of at least one wavelength within the infrared spectrum from 900 nm to 1600 nm at an angle of incidence<15° and an average transmittance of less than 5% in the visible spectrum from 420 nm to 650 nm at an angle of incidence<15°.

According to a further aspect of the disclosure, a window for a sensing system is provided that includes: a substrate comprising an outer primary surface and an inner primary surface, wherein the outer and inner primary surfaces are opposite of one another; an outer layered film disposed on the outer primary surface of the substrate; and an inner layered film disposed on the inner primary surface of the substrate. The outer layered film comprises a plurality of alternating high index and low index layers. The inner layered film comprises a plurality of alternating high index and low index layers. Each of the high index layers has a refractive index greater than a refractive index of each of the low index layers. The outer layered film comprises a scratch resistant layer having a thickness from about 0.5 μm to about 10 μm. Further, the inner layered film or the outer layered film comprises a transparent conductive oxide layer. The outer layered film exhibits a hardness of at least 11 GPa, as measured with a Berkovich Indenter Hardness Test from the outermost surface of the outer layered film to a depth of 1 μm. Further, the quantity, thicknesses and materials of the plurality of alternating high index and low index layers of the outer layered film and the inner layered film are configured so that the window exhibits an average transmittance of greater than 85% within ±25 nm of at least one wavelength within the infrared spectrum from 900 nm to 1600 nm at an angle of incidence<15° and an average transmittance of less than 5% in the visible spectrum from 420 nm to 650 nm at an angle of incidence<15°.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a side view of a vehicle in an external environment, illustrating a LIDAR system on a roof of the vehicle and another LIDAR system on a forward portion of the vehicle;

FIG. 2 is a schematic view of one of the LIDAR systems of FIG. 1, illustrating an electromagnetic radiation emitter and sensor in an enclosure, and the electromagnetic radiation emitter and sensor emitting electromagnetic radiation that exits the enclosure through a window and returns as reflected radiation through the window;

FIG. 3 is a cross-sectional view of two embodiments of the window of FIG. 2 taken at area III of FIG. 2, illustrating each window as including a substrate with an outer layered film over an outer primary surface of the substrate, and an inner layered film over an inner primary surface of the substrate;

FIG. 4A is a cross-sectional view of one of the windows of FIG. 3 taken at area IV-A of FIG. 3, illustrating the outer layered film including alternating layers of one or more higher refractive index materials and one or more lower refractive index materials with a layer of the one or more lower refractive index materials providing a terminal surface closest to the external environment;

FIG. 4B is a cross-sectional view of one of the windows of FIG. 3 taken at area IV-B of FIG. 3, illustrating the inner layered film including alternating layers of one or more higher refractive index materials and one or more lower refractive index materials with a layer of the one or more lower refractive index materials providing a terminal surface closest to the electromagnetic radiation emitter and sensor;

FIG. 5A is a cross-sectional view of one of the windows of FIG. 3 taken at area V-A of FIG. 3, illustrating the outer layered film including alternating layers of one or more higher refractive index materials and one or more lower refractive index materials with a layer of the one or more lower refractive index materials providing a terminal surface closest to the external environment;

FIG. 5B is a cross-sectional view of one of the windows of FIG. 3 taken at area V-B of FIG. 3, illustrating the inner layered film including alternating layers of one or more higher refractive index materials and one or more lower refractive index materials with a layer of the one or more lower refractive index materials providing a terminal surface closest to the electromagnetic radiation emitter and sensor;

FIG. 6A is a chart of modeled two-surface transmittance vs. wavelength for an exemplary window of the disclosure, from 1500 nm to 1600 nm at normal incidence from the outside and inside surfaces of the window;

FIG. 6B is a chart of modeled two-surface S & P polarization transmittance vs. wavelength for an exemplary window of the disclosure, from 1500 nm to 1600 nm at 60° incidence from the outside and inside surfaces of the window;

FIG. 6C is a chart of modeled two-surface reflectance vs. wavelength for an exemplary window of the disclosure, from 1500 nm to 1600 nm at normal incidence from the outside and inside surfaces of the window;

FIG. 6D is a chart of modeled two-surface transmittance vs. wavelength for an exemplary window of the disclosure, from 400 nm to 700 nm at normal incidence from the outside and inside surfaces of the window;

FIG. 6E is a chart of modeled reflected color for an exemplary window of the disclosure, from normal to 90° degrees incidence from the outside and inside surface of the window;

FIG. 6F is a chart of measured Berkovich nanoindentation hardness vs. displacement into the outer surface of an exemplary window of the disclosure;

FIG. 6G is a chart of measured attenuation of microwave radiation through exemplary windows of the disclosure vs. thickness of the indium zinc oxide layer within these windows;

FIG. 7A is a chart of modeled two-surface transmittance vs. wavelength for an exemplary window of the disclosure, from 1500 nm to 1600 nm at normal incidence from the outside and inside surfaces of the window;

FIG. 7B is a chart of modeled two-surface S & P polarization transmittance vs. wavelength for an exemplary window of the disclosure, from 1500 nm to 1600 nm at 60° incidence from the outside and inside surfaces of the window;

FIG. 7C is a chart of modeled two-surface reflectance vs. wavelength for an exemplary window of the disclosure, from 1500 nm to 1600 nm at normal incidence from the outside and inside surfaces of the window;

FIG. 7D is a chart of modeled two-surface transmittance vs. wavelength for an exemplary window of the disclosure, from 400 nm to 700 nm at normal incidence from the outside and inside surfaces of the window;

FIG. 8A is a chart of modeled two-surface transmittance vs. wavelength for an exemplary window of the disclosure, from 1500 nm to 1600 nm at a 15° angle of incidence from the outside and inside surfaces of the window;

FIG. 8B is a chart of modeled two-surface S & P polarization transmittance vs. wavelength for an exemplary window of the disclosure, from 1500 nm to 1600 nm at 60° incidence from the outside and inside surfaces of the window;

FIG. 8C is a chart of modeled two-surface reflectance vs. wavelength for an exemplary window of the disclosure, from 1500 nm to 1600 nm at a 15° angle of incidence from the outside and inside surfaces of the window;

FIG. 8D is a chart of modeled two-surface transmittance vs. wavelength for an exemplary window of the disclosure, from 400 nm to 700 nm at a 15° angle of incidence from the outside and inside surfaces of the window; and

FIG. 8E is a chart of modeled reflected color for an exemplary window of the disclosure, from normal to 90° degrees incidence from the outside and inside surface of the window.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example “up,” “down,” “right,” “left,” “front,” “back,” “top,” “bottom”—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

The present disclosure addresses the foregoing problems and concerns with LIDAR systems. The durable windows of the disclosure generally include inner and outer layered films, at least one of which including one or more layers of material that provides hardness and scratch resistance to the windows. Thus, rocks and other objects impacting the window are less likely to cause defects to the window that scatter the emitted and reflected electromagnetic radiation from the LIDAR sensor and, therefore, improves the performance thereof. In addition, the layered films further include alternating layers of materials having different indices of refraction (including the material providing the hardness and scratch resistance), such that the number of alternating layers and their thicknesses can be configured so that the window has high transmissivity and low reflection at infrared wavelengths (e.g., 905 nm, 1550 nm, etc.), as well as low transmissivity and high reflection of visible light wavelengths, if desired. Further, one or both of the inner and outer layered films can include one or more layers that absorb ultraviolet and visible light wavelengths and/or one or more transparent conductive oxide layers which can provide microwave shielding, if desired.

Reference will now be made in detail to the present preferred embodiments, examples of which are illustrated in the accompanying drawings. Whenever possible, the same reference numerals will be used throughout the drawings to refer to the same or like parts.

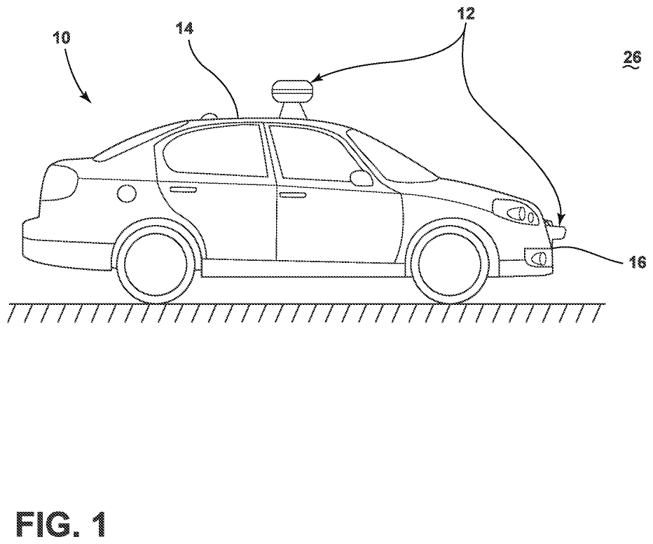

Referring now to FIG. 1, a vehicle 10 includes one or more LIDAR systems 12. The one or more LIDAR systems 12 can be disposed anywhere on or within the vehicle 10. For example, the one or more LIDAR systems 12 can be disposed on a roof 14 of the vehicle 10 and/or a forward portion 16 of the vehicle 10.

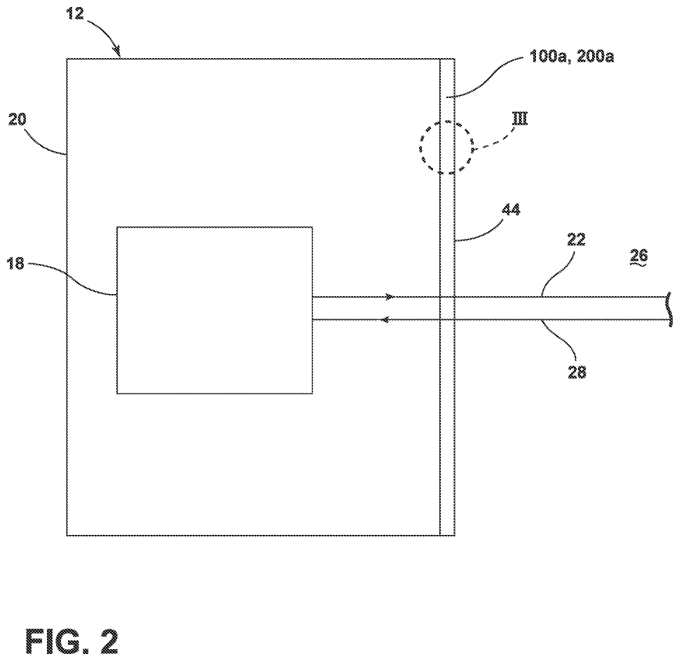

Referring now to FIG. 2, each of the one or more LIDAR systems 12 includes an electromagnetic radiation emitter and sensor 18, as known in the art, which may be enclosed in an enclosure 20. The electromagnetic radiation emitter and sensor 18 emits electromagnetic radiation 22 having a wavelength or range of wavelengths. The emitted radiation 22 exits the enclosure 20 through a window 100a, 200a, which is in the path of the emitted electromagnetic radiation. If an object (not illustrated) in an external environment 26 is in the path of the emitted radiation 22, the emitted radiation 22 will reflect off of the object and return to the electromagnetic radiation emitter and sensor 18 as reflected radiation 28. The reflected radiation 28 again passes through the window 100a, 200a to reach the electromagnetic radiation emitter and sensor 18. In embodiments, the emitted radiation 22 and the reflected radiation 28 have a wavelength of 905 nm or 1550 nm or a range including either the 905 nm or 1550 nm wavelengths. Electromagnetic radiation other than the reflected radiation 28 (such as electromagnetic radiation having wavelengths in the visible spectrum, portions of the ultraviolet range, portions of the infrared range shorter than the desired 905 nm and/or 1550 nm wavelengths, and/or microwave radiation) may or may not pass through the window 100a, 200a, depending on the optical properties of the window 100a, 200a as described herein.

As used herein, the “visible spectrum” is the portion of the electromagnetic spectrum that is visible to the human eye and generally refers to electromagnetic radiation having a wavelength within the range of about 380 nm or 400 nm to about 700 nm. The “ultraviolet range” is the portion of the electromagnetic spectrum having wavelengths between about 10 nm and about 400 nm. The “infrared range” of the electromagnetic spectrum begins at about 700 nm and extends to longer wavelengths. The sun generates solar electromagnetic radiation, commonly referred to as “sunlight,” having wavelengths that fall within all three of those ranges. Further, as used herein, “microwave radiation” is defined as electromagnetic radiation emanating at frequencies of 0.3 GHz or greater (e.g., 0.3 GHz to 100 GHz), including mobile phones that operate in the 5G mobile phone network.

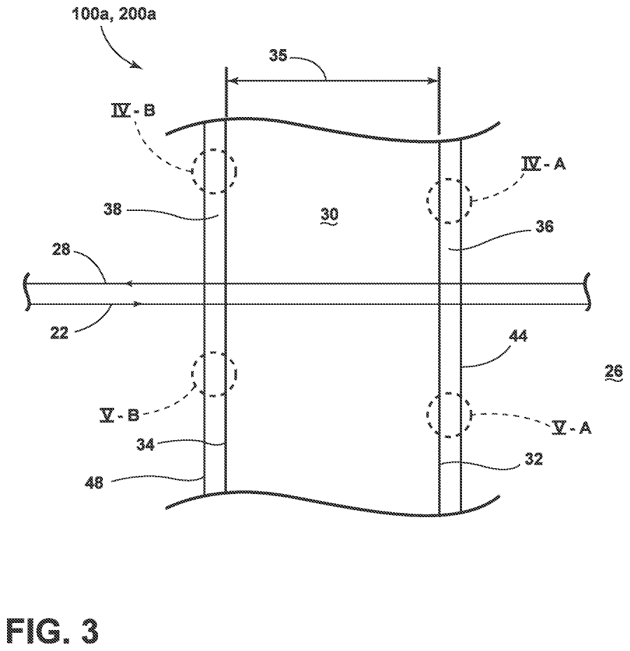

Referring now to FIG. 3, the window 100a, 200a for each of the one or more LIDAR systems 12 includes a substrate 30. The substrate 30 includes an outer primary surface 32 and an inner primary surface 34. The outer primary surface 32 and the inner primary surface 34 are primary surfaces of the substrate 30 that oppose one another. The outer primary surface 32 is closest to the external environment 26. The inner primary surface 34 is closest to the electromagnetic radiation emitter and sensor 18. The emitted radiation 22 encounters the inner primary surface 34 before the outer primary surface 32. The reflected radiation 28 encounters the outer primary surface 32 before the inner primary surface 34. The substrate 30 further includes an outer layered film 36 disposed on the outer primary surface 32 of the substrate 30, and an inner layered film 38 is disposed on the inner primary surface 34 of the substrate 30. It should be understood that the window 100a, 200a, as described herein, is not limited to vehicular applications, and can be used for whatever application the window 100a, 200a would be useful to provide improved impact and optical performance, as described further herein.

As used herein, the term “dispose” includes coating, depositing and/or forming a material onto a surface using any known method in the art. The disposed material may constitute a layer, as defined herein. The phrase “disposed on” includes the instance of forming a material onto a surface such that the material is in direct contact with the surface and also includes the instance where the material is formed on a surface, with one or more intervening material(s) between the disposed material and the surface. The intervening material(s) may constitute a layer, as defined herein.

The substrate 30 can be a glass substrate. The glass substrate can have a composition of soda lime glass, alkali aluminosilicate glass, alkali containing borosilicate glass, and alkali aluminoborosilicate glass, although other glass compositions are contemplated. Such glass compositions are capable of being chemically strengthened by an ion-exchange process. In some variants, the composition may be free of lithium ions.

An alkali aluminosilicate glass composition suitable for the substrate 30 comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio (Al₂O₃+B₂O₃)/Σ_{modifiers} (i.e., sum of modifiers) is greater than 1, wherein the ratio of the components are expressed in mol. % and the modifiers are alkali metal oxides. This composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio (Al₂O₃+B₂O₃)/Σ_{modifiers} (i.e., sum of modifiers) is greater than 1.

Another suitable alkali aluminosilicate glass composition for the substrate 30 comprises: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)—Al₂O₃≤2 mol. %; 2 mol. %≤Na₂O—Al₂O₃≤6 mol. %; and 4 mol. %≤(Na₂O+K₂O)—Al₂O₃ 10 mol. %. Another suitable alkali aluminosilicate glass composition for the substrate 30 comprises: 2 mol. % or more of Al₂O₃ and/or ZrO₂, or 4 mol. % or more of Al₂O₃ and/or ZrO₂.

One example glass composition comprises SiO₂, B₂O₃, and Na₂O, where (SiO₂+B₂O₃) 66 mol. %, and Na₂O 9 mol. %. In an embodiment, the composition includes at least 6 wt. % aluminum oxide. In a further embodiment, the composition of one or more alkaline earth oxides, such as a content of alkaline earth oxides, is at least 5 wt. %. Suitable compositions, in some embodiments, further comprise at least one of K₂O, MgO, and CaO. In a particular embodiment, the composition of the substrate 30 comprises 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example composition suitable for the substrate 30 comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. 0% SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %. A still further example glass composition suitable for the substrate 30 comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

The substrate 30 may be substantially planar or sheet-like, although other embodiments may utilize a curved or otherwise shaped or sculpted substrate. The length and width of the substrate 30 can vary according to the dimensions required for the window 100a, 200a. The substrate 30 can be formed using various methods, such as float glass processes and down-draw processes such as fusion draw and slot draw. The substrate 30 can be used in a non-strengthened state. A commercially available example of a suitable non-strengthened substrate 30 for the window 100a, 200a is Corning® Gorilla® Glass 3, which is a sodium aluminosilicate glass substrate.

The glass forming the substrate 30 can be modified to have a region contiguous with the outer primary surface 32 and/or a region contiguous with the inner primary surface 34 to be under compressive stress (“CS”). In such a circumstance, the region(s) under compressive stress extends from the outer primary surface 32 and/or the inner primary surface 34 to a depth(s) of compression. This generation of compressive stress further creates a central region that is under a tensile stress, having a maximum value at the center of the central region, referred to as central tension or center tension (CT). The central region extends between the depths of compression, and is under tensile stress. The tensile stress of the central region balances or counteracts the compressive stresses of the regions under compressive stress. As used herein, the terms “depth of compression” and “DOC” refer to the depth at which the stress within the substrate 30 changes from compressive to tensile stress. At the depth of compression, the stress crosses from a positive (compressive) stress to a negative (tensile) stress and thus has a value of zero. The depth of compression protects the substrate 30 from the propagation of flaws introduced by sharp impact to the outer and/or inner primary surfaces 32, 34 of the substrate 30, while the compressive stress minimizes the likelihood of a flaw growing and penetrating through the depths of compression. In embodiments, the depths of compression are each at least 20 μm. In embodiments, the absolute value of the maximum compressive stress CS within the regions is at least 200 MPa, at least about 400 MPa, at least 600 MPa, or up to about 1000 MPa.

Two methods for extracting detailed and precise stress profiles (stress as a function of depth) for a substrate 30 with regions under compressive stress are disclosed in U.S. Pat. No. 9,140,543, entitled “Systems and Methods for Measuring the Stress Profile of Ion-Exchanged Glass,” filed by Douglas Clippinger Allan et al. on May 3, 2012, and claiming priority to U.S. Provisional Patent Application No. 61/489,800, having the same title, and filed on May 25, 2011, the contents of which are incorporated herein by reference in their entirety.

In embodiments, generating the region(s) of the substrate 30 under compressive stress includes subjecting the substrate 30 to an ion-exchange chemical tempering process (chemical tempering is often referred to as “chemical strengthening”). In the ion-exchange chemical tempering process, ions at or near the outer and inner primary surfaces 32, 34 of the substrate 30 are replaced by—or exchanged with—larger ions usually having the same valence or oxidation state. In those embodiments in which the substrate 30 comprises, consists essentially of, or consists of an alkali aluminosilicate glass, an alkali borosilicate glass, an alkali aluminoborosilicate glass, or an alkali silicate glass, ions in the surface layer of the glass and the larger ions are monovalent alkali metal cations, such as Na⁺ (when Li⁺ is present in the glass), K⁺, Rb⁺, and Cs⁺. Alternatively, monovalent cations in, at, or near the outer and inner primary surfaces 32, 34 may be replaced with monovalent cations other than alkali metal cations, such as Ag⁺ or the like.

In embodiments, the ion-exchange process is carried out by immersing the substrate 30 in a molten salt bath containing the larger ions to be exchanged with the smaller ions in the substrate 30. It will be appreciated by those skilled in the art that parameters for the ion-exchange process, including, but not limited to, bath composition and temperature, immersion time, the number of immersions of the glass in a salt bath (or baths), use of multiple salt baths, and additional steps such as annealing, washing and the like, are generally determined by the composition of the substrate 30 and the desired depths of compression and compressive stress of the substrate 30 that result from the strengthening operation. By way of example, ion-exchange of alkali metal-containing glass substrates may be achieved by immersion in at least one molten bath containing a salt such as, but not limited to, nitrates, sulfates, and chlorides of the larger alkali metal ion. In embodiments, the molten salt bath comprises potassium nitrate (0-100 wt %), sodium nitrate (0-100 wt %), and lithium nitrate (0-12 wt %), the combined potassium nitrate and sodium nitrate having a weight percentage within the range of 88 wt % to 100 wt %. In embodiments, the temperature of the molten salt bath typically is in a range from about 350° C. up to about 500° C., while immersion times range from about 15 minutes up to about 40 hours, including from about 20 minutes to about 10 hours. However, temperatures and immersion times different from those described above may also be used. The substrate 30 may be acid polished or otherwise treated to remove or reduce the effect of surface flaws.

The substrate 30 has a thickness 35 defined as the shortest straight-line distance between the outer primary surface 32 and the inner primary surface 34. In embodiments, the thickness 35 of the substrate 30 is between about 100 μm and about 5 mm. The substrate 30, according to one or more embodiments, can have a physical thickness 35 ranging from about 100 μm to about 500 μm (e.g., 100, 200, 300, 400, or 500 μm). In other embodiments, the thickness 35 ranges from about 500 μm to about 1000 μm (e.g., 500, 600, 700, 800, 900, or 1000 μm). The thickness 35 may be greater than about 1 mm (e.g., about 2, 3, 4, or 5 mm). In one or more specific embodiments, the thickness 35 is 2 mm or less or less than 1 mm. A commercially available composition suitable for the substrate 30 that has been subjected to ion-exchange is a Gorilla® Glass, with the glass having a CS of about 850 MPa, a DOC of about 40 microns, and a thickness 35 of 1.0 millimeter (mm). Another commercially available example of a suitable strengthened (through ion-exchange) substrate 30 for the window 100a, 200a is Corning® Gorilla® Glass 3, which is a sodium aluminosilicate glass substrate.

Instead of glass, or in addition to glass, the substrate 30 can include or be a visible light absorbing, IR-transmitting material layer. Examples of such materials include infrared transmitting, visible absorbing acrylic sheets, such as those commercially available from ePlastics under the trade names Plexiglas® IR acrylic 3143 and CYRO's ACRYLITE® IR acrylic 1146. Plexiglas® IR acrylic 3143 has a transmissivity of about 0% (at least less than 10%, or less than 1%) for electromagnetic radiation having wavelengths of about 700 nm or shorter, but a transmissivity of about 90% (above 85%) for wavelengths within the range of 800 nm to about 1100 nm (including 905 nm).

In embodiments, the substrate 30 includes an organic or suitable polymeric material. Examples of suitable polymers include, without limitation: thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins (PO) and cyclicpolyolefins (cyclic-PO), polyvinylchloride (PVC), acrylic polymers including polymethyl methacrylate (PMMA) (including copolymers and blends), thermoplastic urethanes (TPU), polyetherimide (PEI) and blends of these polymers with each other. Other exemplary polymers include epoxy, styrenic, phenolic, melamine, and silicone resins.

In embodiments, the substrate 30 includes a plurality of layers or sub-layers. The layers or sub-layers of the substrate 30 may be the same composition or different compositions from one another. In embodiments, for example, the substrate 30 comprises a glass laminate structure. In embodiments, the glass laminate structure comprises a glazing comprising a first pane and a second pane attached to one another via a suitable interlayer (e.g., a polymer interlayer) disposed between the first pane and the second pane. In embodiments, the glass laminate structure comprises a glass-on-glass laminate structure formed via, for example, the fusion draw process. Glass-polymer laminates are also contemplated and within the scope of the present disclosure. Any material capable of meeting the optical requirements described herein may be used as the substrate 30.

In embodiments, the substrate 30 exhibits an average transmittance over the visible wavelength regime of about 85% or greater, about 86% or greater, about 87% or greater, about 88% or greater, about 89% or greater, about 90% or greater, about 91% or greater or about 92% or greater. In embodiments, the substrate 30 comprises a tinting component (e.g., tinting layer or additive) and may optionally exhibit a color, such as white, black, red, blue, green, yellow, orange etc.

In one or more embodiments, the substrate 30 exhibits a refractive index in the range from about 1.45 to about 1.55. As used herein “refractive index” refers to the refractive index of the material (here, the substrate 30) for electromagnetic radiation having a wavelength of 1550 nm, unless otherwise noted. Here, “refractive index” and “index of refraction” are used synonymously.

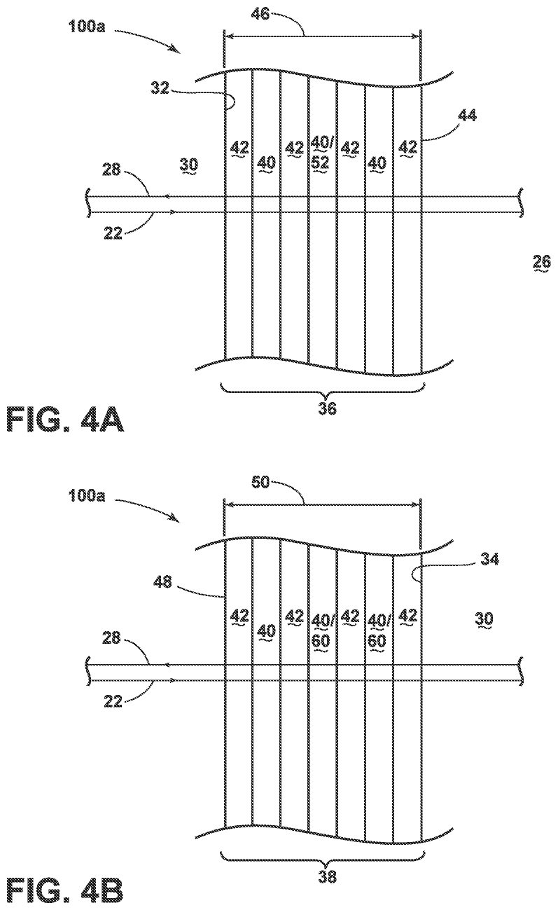

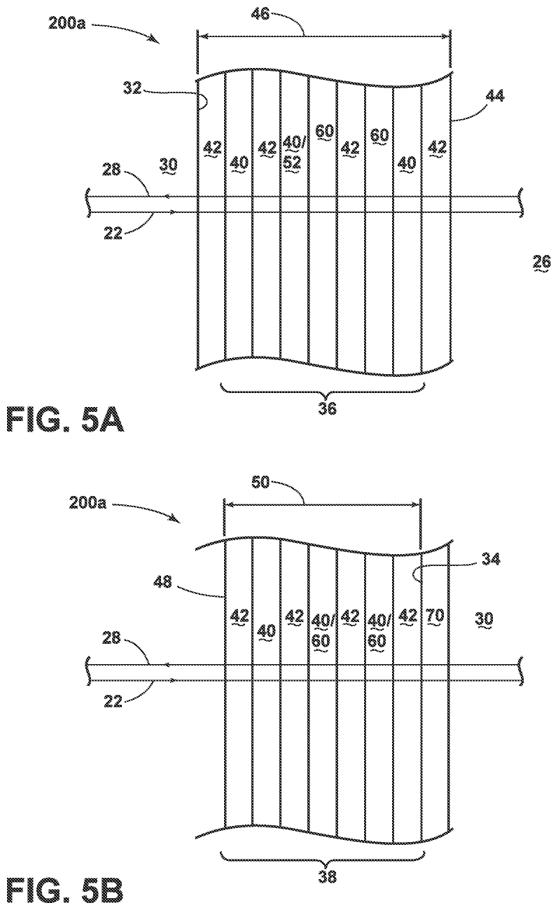

Referring now to FIGS. 4A, 4B, 5A and 5B, each of the outer layered film 36 and the inner layered film 38 of the window 100a, 200a includes a quantity of alternating layers of one or more high refractive index layers 40 and one or more low refractive index layers 42. As used herein, the terms “high refractive index” and “low refractive index” refer to the values of the refractive index relative to each other, with the refractive index/indices of the one or more high refractive index layers 40 being greater than the refractive index/indices of the one or more low refractive index layers 42. In embodiments, the one or more high refractive index layers 40 have a refractive index from about 1.7 to about 4.0. In embodiments, the one or more low refractive index layers 42 have a refractive index from about 1.3 to about 1.6. In other embodiments, the one or more low refractive index layers 42 have a refractive index from about 1.3 to about 1.7, while the one or more high refractive index layers 40 have a refractive index from about 1.9 to about 3.8. The difference in the refractive index of any of the one or more high refractive index layers 40 and any of the one or more low refractive index layers 42 may be about 0.1 or greater, 0.2 or greater, 0.3 or greater, 0.4 or greater, 0.5 or greater, 0.6 or greater, 0.7 or greater, 0.8 or greater, 0.9 or greater, 1.0 or greater, 1.5 or greater, 2.0 or greater, 2.1 or greater, 2.2 or greater, or even 2.3 or greater.

Because of the difference in the refractive indices of the one or more high refractive index layers 40 and the one or more low refractive index layers 42, manipulation of the quantity (number) of alternating layers and their thicknesses can cause selective transmission of electromagnetic radiation within a range of wavelengths through the window 100a, 200a, and, separately, selective reflectance of electromagnetic radiation within a range of wavelengths off of and/or through the outer layered film 36 and the inner layered film 38. Thus, each of the outer layered film 36 and the inner layered film 38 is a thin-film optical filter having predetermined optical properties configured as a function of the quantity, thicknesses, and layers chosen as the one or more high refractive index layers 40 and the one or more low refractive index layers 42.

According to some implementations of the window 100a, 200a depicted in FIGS. 4A-5B, each of the high refractive index layers 40 has a physical thickness that ranges from 25 nm to 750 nm, 40 nm to 600 nm, 50 nm to 500 nm, and all ranges and thickness values between the foregoing ranges. According to some implementations of the window 100a, 200a depicted in FIGS. 4A-5B, each of the low refractive index layers 42 has a physical thickness that ranges from 5 nm to 800 nm, 10 nm to 700 nm, 15 nm to 600 nm, and all ranges and thickness values between the foregoing ranges.

Some examples of suitable materials for use as the one or more low refractive index layers 42 include SiO₂, Al₂O₃, GeO₂, SiO, AlOₓN_{y}, SiOₓN_{y}, Siᵤ AlᵥOₓN_{y}, MgO, MgAl₂O₄, MgF₂, BaF₂, CaF₂, DyF₃, YbF₃, YF₃, and CeF₃. The nitrogen content of the materials for use as the one or more low refractive index layers 42 may be minimized (e.g., in materials such as AlOₓN_{y}, SiOₓN_{y}, and Siᵤ AlᵥOₓN_{y}).

Some examples of suitable materials for use as the one or more high refractive index layers 40 include amorphous silicon (a-Si), SiNₓ, SiNₓ:H_{y}, AlNₓ, Siᵤ AlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, MoO₃, and diamond-like carbon. The oxygen content of the materials for the high refractive index layers 40 may be minimized, especially in SiNₓ or AlNₓ materials. AlOₓN_{y} materials may be considered to be oxygen-doped AlNₓ, that is they may have an AlNₓ crystal structure (e.g., wurtzite) and need not have an AlON crystal structure. Exemplary preferred AlOₓN_{y} materials for use as the one or more high refractive index layers 40 may comprise from about 0 atom % to about 20 atom % oxygen, or from about 5 atom % to about 15 atom % oxygen, while including 30 atom % to about 50 atom % nitrogen. Exemplary preferred SiᵤAlᵥOₓN_{y} for use as the one or more high refractive index layers 40 may comprise from about 10 atom % to about 30 atom % or from about 15 atom % to about 25 atom % silicon, from about 20 atom % to about 40 atom % or from about 25 atom % to about 35 atom % aluminum, from about 0 atom % to about 20 atom % or from about 1 atom % to about 20 atom % oxygen, and from about 30 atom % to about 50 atom % nitrogen. The foregoing materials may be hydrogenated up to about 30% by weight. Because the refractive indices of the one or more high refractive index layers 40 and the one or more low refractive index layers 42 are relative to each other, the same material (such as Al₂O₃) can be appropriate for the one or more high refractive index layers 40 depending on the refractive index of the material(s) chosen for the one or more low refractive index layers 42, and can alternatively be appropriate for the one or more low refractive index layers 42 depending on the refractive index of the material(s) chosen for the one or more high refractive index layers 40.

In embodiments of the window 100a, 200a depicted in FIGS. 4A-5B, the one or more low refractive index layers 42 of the outer layered film 36 and inner layered film 38 consists of layers of SiO₂, and the one or more high refractive index layers 40 of the outer layered film 36 and inner layered film 38 consists of layers of AlNₓ, AlOₓN_{y}, SiOₓN_{y}, Si₃N₄ or SiNₓ. In some of these implementations, some of the high refractive index layers 40 consist of SiOₓN_{y} and some of the high refractive index layer 40 consist of Si₃N₄. Hence, various combinations of high refractive index layers 40 may be present in the outer and inner layered films 36, 38 of the window 100a, 200a.

In embodiments of the window 100a, 200a depicted in FIGS. 4A-5B, one or more of the high refractive index layers 40 of the inner layered film 38 consists of absorption layers 60. In some embodiments of the window 100a, 200a, the inner layered film 38 comprises one or more absorption layers 60. Also as depicted in FIGS. 4B and 5B, some of the high refractive index layers 40 of the inner layered film 38 of the window 100a, 200a can consist of absorption layers 60, none of which are in direct contact with the inner primary surface 34 of the substrate 30. In embodiments, the one or more low refractive index layers 42 of the outer layered film 36 consists of layers of SiO₂, and the one or more high refractive index layers 40 of the outer layered film 36 consists of layers of AlNₓ, AlOₓN_{y}, SiOₓN_{y}, Si₃N₄ or SiNₓ, while the one or more low refractive index layers 42 of the inner layered film 38 consists of layers of SiO₂ and the one or more high refractive index layers 40 of the inner layered film 38 consists of absorption layers 60 of amorphous silicon (a-Si) and layers of Si₃N₄. Further, according to the window 100a, 200a depicted in FIGS. 4A-5B, the absorption layers have a physical thickness that ranges from 10 nm to 400 nm, 20 nm to 350 nm, from 25 nm to 300 nm, and all ranges and thickness values between the foregoing ranges.

In some embodiments of the window 200a depicted in FIGS. 5A and 5B, the inner and/or outer layered film 38, 36 can include one or more absorption layers 60. As shown in FIG. 5B, for example, an outer layered film 36 can be configured with one or more absorption layers 60 that reside adjacent to a high refractive index layer 40 or a low refractive index layer 42, none of which are in direct contact with the outer primary surface 32 of the substrate 30. In other embodiments of the window 200a, the outer layered film 36 can be configured with one or more absorption layers 60 in place of one or more high refractive index layers 40 and low refractive index layers 42.

In those implementations of the window 100a, 200a that include one or more absorption layers 60, each of the absorption layers can be amorphous silicon (a-Si), germanium (Ge) or gallium arsenide (GaAs). In some implementations of the window 100a, 200a that include one or more absorption layers 60, each of the absorption layers can comprise a refractive index of 3.0 or greater. Further, in some implementations of the window 100a, 200a that include one or more absorption layers 60, each of the absorption layers can comprise an extinction coefficient of 0.1 or greater at one or more wavelengths in the ultraviolet and visible spectra from 100 nm to 700 nm.

In embodiments of the window 200a depicted in FIGS. 5A-5B, the outer layered film 36 or inner layered film 38 can include one or more transparent conductive oxide (TCO) layers 70. For example, a transparent conductive oxide layer 70 in an outer layered film 36 can be positioned between the substrate 30 and a scratch resistant layer 52 (as detailed below in the disclosure). As another example, a transparent conductive oxide layer 70 in an inner layered film 38 can be positioned between the substrate 30 and one of the high refractive index layers 40 or low refractive index layers 42 (see FIG. 5B). In one implementation, as depicted in FIG. 5B, the inner layered film 38 is positioned in contact with the inner primary surface 34 of the substrate 30 and between a low refractive index layer 42 and the substrate 30.

In embodiments, the transparent conductive oxide layer(s) 70 employed in the window 200a, in combination with the quantity, thicknesses and materials of the outer and inner layered films 36, 38, function to shield the components located behind the window 200a from microwave radiation. In some embodiments of the window 200a, as depicted in exemplary form in FIGS. 5A and 5B, the transparent conductive oxide layers 70, in combination with the quantity, thicknesses and materials of the outer and inner layered films 36, 38, are configured such that the window 200a exhibits an energy attenuation of at least 15 dB for microwave radiation of greater than 1 GHz. As used herein, “energy attenuation” of microwave radiation is measured using a network analyzer. Unless otherwise noted, a window according to the disclosure is placed between two Faraday cages with a microwave transmitter in one cage and a microwave receiver in the other cage. Measurements and energy attenuation (in units of “dB”) can then be conducted and calculated according to techniques in the field of the disclosure, e.g., Maniyara, R. et al., “An antireflection transparent conductor with ultralow optical loss (<2%) and electrical resistance (<Ω sq⁻¹)”, Nature Communications, vol. 7, Art. No. 13771 (2016), the contents of which is incorporated herein by reference in its entirety.

In some embodiments of the window 200a, as depicted in exemplary form in FIGS. 5A and 5B, the transparent conductive oxide layers 70, in combination with the quantity, thicknesses and materials of the outer and inner layered films 36, 38, are configured such that the window 200a exhibits an energy attenuation of at least 2 dB, 4 dB, 6 dB, 8 dB, 10 dB, 12 dB, 13 dB, 14 dB, or 15 dB for microwave radiation of from 1 GHz to 50 GHz, from 1 GHz to 40 GHz, or from 1 GHz to 30 GHz. For example, the transparent conductive oxide layers 70, in combination with the quantity, thicknesses and materials of the outer and inner layered films 36, 38, are configured such that the window 200a exhibits an energy attenuation of at least 2 dB, 4 dB, 6 dB, 8 dB, 10 dB, 12 dB, 13 dB, 14 dB, or 15 dB for microwave radiation at 1.5 GHz and/or 25 GHz.

In those embodiments of the window 200a comprising one or more transparent conductive oxide layers 70, the TCO layers 70 can be of any transparent conductive oxide materials understood by those in the field of the disclosure. Suitable materials for the transparent conductive oxide layers 70 include SnO₂, In₂O₃, ZnO, CdO, ZnO—SnO₂, ZnO—In₂O₃, In₂Or-SnO₂, CdO—In₂O₃, MgIn₂O₄, GaInO₃, CdSb₂O₆, ZnO—In₂O₃—SnO₂, CdO—In₂O₃—SnO₂, and ZnO—CdO—In₂O₃—SnO₂. In some implementations, any of the foregoing TCO materials suitable for use in the transparent conductive oxide layers 70 of the window 200a may be doped with F, Al₂O₃, Sb, As, Nb, Ta, Ge and other dopants as understood by those in the field of the disclosure. In preferred implementations, the transparent conductive oxide layers 70 are of F-doped SnO₂ (FTO), Sn-doped In₂O₃ (ITO), ZnO₂, Al₂O₃-doped ZnO₂ (AZO), and In₂O₃-doped ZnO₂ (IZO). Further, according to the window 200a depicted in FIGS. 5A-5B, each of the transparent conductive oxide layers 70 have a physical thickness that ranges from 50 nm to 400 nm, 75 nm to 300 nm, from 100 nm to 250 nm, and all ranges and thickness values between the foregoing ranges.

The quantity of alternating high refractive index layers 40 and low refractive index layers 42 in either of the outer layered film 36 or the inner layered film 38 is not particularly limited. In embodiments, the number of alternating layers within each of the outer layered film 36 and the inner layered film 38 is 7 or more, or 9 or more. In embodiments, the quantity of alternating layers within the outer layered film 36 and/or the inner layered film 38 is 9 or more, 17 or more, 19 or more, or 81 or more. In embodiments, the quantity of alternating layers in the outer layered film 36 and the inner layered film 38 collectively forming the window 100a, 200a, not including the substrate 30, is 9 or more, 16 or more, 24 or more, 26 or more, or even 88 or more. In embodiments of the window 100a, 200a, the plurality of alternating high and low refractive index layers 40, 42 in the outer layered film 36 is from 5 to 15 layers. In embodiments of the window 100a, 200a, the plurality of alternating high and low refractive index layers 40, 42 in the inner layered film 38 is from 5 to 15 layers. According to an embodiment, the plurality of alternating high and low refractive index layers 40, 42 in the outer and inner layered films 36, 38 is from 5 to 15 layers, e.g., 9-13 layers for the outer layered film 36 and 9-13 layers for the inner layered film 38.

In general, the greater the quantity of layers within the outer layered film 36 and the inner layered film 38, the more narrowly the transmittance and reflectance properties of the window 100a, 200a are tailored to one or more specific wavelengths or wavelength ranges. Further, each of the alternating high and low refractive index layers 40, 42 of the outer layered film 36 and the inner layered film 38 has a thickness.

In some embodiments of the window 100a, 200a, as depicted in FIGS. 4A-5B, a low refractive index layer 42 of the outer layered film 36 can be disposed in contact with the outer primary surface 32 of the substrate 30. The reflected radiation 28 first encounters a terminal surface 44 of the outer layered film 36 upon interacting with the window 100a, 200a, as depicted in FIGS. 4A, 4B, 5A and 5B, and the terminal surface 44 may be open to the external environment 26. In an embodiment, one or more low refractive index layers 42 provides the terminal surface 44 to more closely match the refractive index of the air in the external environment 26 and thus reduce reflection of incident electromagnetic radiation (whether the reflected radiation 28 or otherwise) off of the terminal surface 44. The one or more low refractive index layers 42 that provides the terminal surface 44 is the layer of the outer layered film 36 that is farthest from the substrate 30. Similarly, in an embodiment, when the one or more low refractive index layers 42 is SiO₂, a layer of SiO₂, as the one or more low refractive index layers 42, is disposed directly onto and in contact with the outer primary surface 32 of the substrate 30, which will typically comprise a large mole percentage of SiO₂. Without being bound by theory, it is thought that commonality of SiO₂ in both the substrate 30 and the adjacent layer of the one or more low refractive index layers 42 allows for increased bonding strength.

In some embodiments of the window 100a, 200a, as depicted in FIGS. 4A-5B, a low refractive index layer 42 of the inner layered film 38 can be disposed in contact with the inner primary surface 34 of the substrate 30. The emitted radiation 22 first encounters a terminal surface 48 of the inner layered film 38 upon interacting with the window 100a, 200a. In an embodiment, one or more low refractive index layers 42 provides the terminal surface 48 to more closely match the refractive index of the air within the enclosure 20 and thus reduce reflection of the incident emitted radiation 22 off of the terminal surface 48. The one or more low refractive index layers 42 that provides the terminal surface 48 is the layer of the inner layered film 38 that is farthest from the substrate 30. Similarly, in an embodiment, when the one or more low refractive index layers 42 is SiO₂, a layer of SiO₂, as the one or more low refractive index layers 42, is disposed directly onto and in contact with the inner primary surface 34 of the substrate 30.

Implementations of the windows 100a, 200a depicted in FIGS. 4A-5B include a scratch resistant layer 52 (which can be one of the high refractive index layers 40) in the outer layered film 36. The scratch resistant layer 52 can have a thickness from about 0.1 m to 10 μm, 0.25 μm to 10 μm, 0.5 μm to 10 μm, 0.1 μm to 5 μm, 0.25 μm to 5 μm, 0.5 μm to 5 μm, 1 μm to 10 μm, or 1 μm to 5 μm. For example, the scratch resistant layer 52 can have a physical thickness of 100 nm, 200 nm, 300 nm, 400 nm, 500 nm, 600 nm, 700 nm, 800 nm, 900 nm, 1000 nm, 1250 nm, 1500 nm, 2000 nm, 2500 nm, 3000 nm, 4000 nm, 5000 nm, 6000 nm, 7000 nm, 8000 nm, 9000 nm, 10000 nm, and all physical thicknesses between the foregoing thicknesses.

Referring again to the scratch resistant layer 52, materials that have a relatively high refractive index can simultaneously have a relatively high hardness that provides scratch and impact resistance. An example material that has both high hardness and can be the scratch resistant layer 52 (and one of the high refractive index layers 40) is Si₃N₄. Other example materials that have both high hardness and can be the scratch resistant layer 52 are SiNₓ, SiNₓ:H_{y}, and SiOₓN_{y}. The thickness of the scratch resistant layer 52, whether at the second layer of the outer layered film 36 or otherwise, can be maximized to increase the scratch and/or damage resistance of the window 100a, 200a. The thickness and location within the outer layered film 36 of the scratch resistant layer 52 can be optimized to provide the desired level of hardness and scratch resistance to the outer layered film 36 and thus the window 100a, 200a as a whole.

Different applications of the window 100a, 200a could lead to different desired thicknesses for the scratch resistant layer 52 serving as the layer providing the hardness and scratch resistance to the window. For example, a window 100a, 200a protecting a LIDAR system 12 on a vehicle 10 may require a different thickness for the scratch resistant layer 52 than a window 100a, 200a protecting a LIDAR system 12 at an office building. In embodiments, the physical thickness of the scratch resistant layer 52 is 40% or more, 45% or more, 50% or more, 55% or more, 60% or more, 65% or more, or 70% or more of the total thickness of the outer layered film 36. In general, the scratch resistant layer 52 serving as the layer providing the hardness and scratch resistance to the window 100a, 200a will be part of the outer layered film 36 facing the external environment 26 rather the inner layered film 38 protected by the enclosure 20, although that may not always be so.

As will be detailed further below, the quantity, thicknesses, and materials of the remaining layers of the outer layered film 36 and the inner layered film 38 can be configured to provide the window 100a, 200a with the desired optical properties (transmittance and reflectance of desired wavelengths) almost regardless of the thickness chosen for the scratch resistant layer 52 serving as the layer providing the hardness and scratch resistance to the window. This insensitivity of the optical properties of the window 100a, 200a as a whole to the thickness of the scratch resistant layer 52 can be influenced by the use of materials in the scratch resistant layer 52 having relatively low or negligible optical absorption of electromagnetic radiation of the target wavelength or wavelength range (i.e., 905 nm and/or 1550 nm). For example, a scratch resistant layer 52 of Si₃N₄ only negligibly absorbs electromagnetic radiation in the 700 nm to 2000 nm wavelength range. This general insensitivity of the thickness of the scratch resistant layer 52 in the outer layered film 36 on the optical properties of the window 100a, 200a, allows for the selection of a physical thickness of the scratch resistant layer 52 to provide specified hardness or scratch resistance requirements for the window. For example, the outer layered film 36 for the window 100a, 200a utilized at the roof 14 of the vehicle 10 may have different hardness and scratch resistance requirements than the outer layered film 36 for the window 100a, 200a utilized at the forward portion 16 of the vehicle 10, and thus a need for a different thickness for the scratch resistant layer 52. This can be achieved without significantly altering the transmittance and reflectance properties of the outer layered film 36 and window 100a, 200a as a whole.

The hardness of the outer layered film 36, and thus the window 100a, 200a, with the scratch resistant layer 52 can be quantified. In some embodiments, the maximum hardness of the window 100a, 200a, measured at the outer layered film 36 with the scratch resistant layer 52, as measured by the Berkovich Indenter Hardness Test, may be about 8 GPa or greater, about 9 GPa or greater, about 10 GPa or greater, about 11 GPa or greater, about 12 GPa or greater, about 13 GPa or greater, about 14 GPa or greater, about 15 GPa or greater, about 16 GPa or greater, about 17 GPa or greater, or about 18 GPa or greater at one or more indentation depths from 50 nm to 1000 nm (measured from the terminal surface 44), and even from 2000 nm to 5000 nm. As used herein, the “Berkovich Indenter Hardness Test” includes measuring the hardness of a material on a surface thereof by indenting the surface with a diamond Berkovich indenter. The Berkovich Indenter Hardness Test includes indenting the terminal surface 44 of the outer layered film 36 with the diamond Berkovich indenter to form an indent to an indentation depth in the range from about 50 nm to about 1000 nm (or the entire thickness of the outer layered film 36, whichever is less) and measuring the maximum hardness from this indentation along the entire indentation depth range or a segment of this indentation depth range (e.g., in the range from about 100 nm to about 600 nm), generally using the methods set forth in Oliver, W. C.; Pharr, G. M. An improved technique for determining hardness and elastic modulus using load and displacement sensing indentation experiments. J. Mater. Res., Vol. 7, No. 6, 1992, 1564-1583; and Oliver, W. C.; Pharr, G. M. Measurement of Hardness and Elastic Modulus by Instrument Indentation: Advances in Understanding and Refinements to Methodology. J. Mater. Res., Vol. 19, No. 1, 2004, 3-20. As used herein, hardness refers to a maximum hardness, and not an average hardness. These levels of hardness improve the resistance of the window 100a, 200a to impact damage from sand, small stones, debris, and other objects encountered while the LIDAR system 12 is used for its intended purpose, such as with the vehicle 10. Accordingly, these levels of hardness reduce or prevent the optical scattering and reduced performance of the LIDAR system 12 that the impact damage would otherwise cause.

In an embodiment, one or more low refractive index layers 42 providing the terminal surface 44 has a thickness that is less than 20%, or even less than 10% of the 1550 nm wavelength of electromagnetic radiation at issue. In embodiments, the thickness of the layer providing the terminal surface 44 is between 150 nm and 310 nm. Minimizing the thickness of that layer providing the terminal surface 44 enhances the scratch and/or damage resistance provided by the scratch resistant layer 52 provided directly under the layer of the one or more low refractive index layers 42 providing the terminal surface 44. As mentioned, in embodiments, the scratch resistant layer 52 imparting the hardness to the window 100a, 200a is the second layer of the outer layered film 36 from the external environment 26, that is adjacent to the one or more low refractive index layers 42 providing the terminal surface 44 of the window 100a, 200a.

The outer layered film 36 has a thickness 46, and the inner layered film 38 has a thickness 50. The thickness 46 of the outer layered film 36, assumed to include the scratch resistant layer 52, may be about 1 μm or greater while still providing the transmittance and reflectance properties described herein. In embodiments, the thickness 46 is in the range of 1 μm to just over 50 μm, including from about 1 μm to about 10 μm, and from about 2500 nm to about 6000 nm. The lower bound of about 1 μm is approximately the minimum thickness 46 that still provides hardness and scratch resistance to the window 100a, 200a. The higher bound of thickness 46 is limited by cost and time required to dispose the layers of the outer layered film 36 onto the substrate 30. In addition, the higher bound of the thickness 46 is limited to prevent the outer layered film 36 from warping the substrate 30, which is dependent upon the thickness of the substrate 30. The thickness 50 of the inner layered film 38 can be any thickness deemed necessary to impart the window 100a, 200a with the desired transmittance and reflectance properties. In embodiments, the thickness 50 of the inner layered film 38 is in the range of about 800 nm to about 7000 nm, of about 800 nm to about 5000 nm, or from about 800 nm to about 3500 nm. If the inner layered film 38 also includes a scratch resistant layer 52 to impart hardness and impact resistance, then the thickness 50 of the inner layered film 38 can be thicker, as described in connection with the layered film 36 above.

While solving the problem discussed above in the background through imparting hardness, impact, and scratch resistance to the window 100a, 200a via the scratch resistant layer 52, the quantity, thicknesses, and materials of the layers of the outer layered film 36 and inner layered film 38 are configured to also maximize transmittance of the reflected radiation 28 through the window 100a, 200a having a wavelength of 905 nm and/or 1550 nm through the window 100a, 200a. In embodiments, the quantity, thicknesses, and materials of the layers of the outer layered film 36 and inner layered film 38 are configured to also maximize transmittance of electromagnetic radiation having wavelengths within the range of 900 nm to 1600 nm through the window 100a, 200a. In embodiments, the quantity, thicknesses, and materials of the layers of the outer layered film 36 and inner layered film 38 are configured so that the window 100a, 200a has an average transmittance of greater than 75%, greater than 80%, greater than 85%, greater than 90%, greater than 92%, greater than 94%, greater than 95%, greater than 98%, greater than 98.5%, greater than 99%, or even greater than 99.5% of electromagnetic radiation within ±25 nm of at least one wavelength within the infrared spectrum from 900 nm to 1600 nm at normal or near normal incidence (i.e., <15° incidence). In embodiments, the quantity, thicknesses, and materials of the layers of the outer layered film 36 and inner layered film 38 are configured so that the window 100a, 200a has an average transmittance of greater than 75%, greater than 80%, greater than 85%, greater than 90%, greater than 92%, greater than 94%, greater than 95%, greater than 98%, greater than 98.5%, greater than 99%, or even greater than 99.5% of electromagnetic radiation having any wavelength within the range of 1500 nm to 1600 nm at normal or near normal incidence (i.e., <15° incidence). In embodiments, the quantity, thicknesses, and materials of the layers of the outer layered film 36 and inner layered film 38 are configured so that the window 100a, 200a has an average transmittance of greater than 75%, greater than 80%, greater than 85%, greater than 90%, greater than 92%, greater than 94%, greater than 95%, greater than 98%, greater than 98.5%, greater than 99%, or even greater than 99.5% of electromagnetic radiation having wavelengths within ±25 nm of 905 nm and/or 1550 nm at normal or near normal incidence (i.e., <15° incidence). In embodiments, the quantity, thicknesses, and materials of the layers of the outer layered film 36 and inner layered film 38 are configured so that the window 100a, 200a has an average transmittance of greater than 75%, greater than 80%, or greater than 85%, of electromagnetic radiation having any wavelength within the range of 880 nm to 1580 nm, or 850 nm to 1800 nm, at normal or near normal incidence (i.e., <15° incidence). The term “transmittance” refers to the percentage of incident optical power within a given wavelength range transmitted through a material (e.g., the window 100a, 200a, the substrate 30, the outer layered film 36, the inner layered film 38 or portions thereof).

According to some embodiments of the window 100a, 200a, the quantity, thicknesses, and materials of the layers of the outer layered film 36 and inner layered film 38 are configured to also maximize S & P polarization transmittance of the reflected radiation 28 through the window 100a, 200a having a wavelength of 905 nm and/or 1550 nm through the window 100a, 200a. In embodiments, the quantity, thicknesses, and materials of the layers of the outer layered film 36 and inner layered film 38 are configured to also maximize S & P polarization transmittance of electromagnetic radiation having wavelengths within the range of 900 nm to 1600 nm through the window 100a, 200a. In embodiments, the quantity, thicknesses, and materials of the layers of the outer layered film 36 and inner layered film 38 are configured so that the window 100a, 200a has an S & P polarization transmittance of greater than 65%, greater than 70%, greater than 75%, greater than 80%, greater than 85%, or greater than 90% of electromagnetic radiation within ±25 nm of at least one wavelength within the infrared spectrum from 900 nm to 1600 nm at an angle of incidence from normal to less than 60°. In embodiments, the quantity, thicknesses, and materials of the layers of the outer layered film 36 and inner layered film 38 are configured so that the window 100a, 200a has an S & P polarization transmittance of greater than 65%, greater than 70%, greater than 75%, greater than 80%, greater than 85%, or greater than 90% of electromagnetic radiation having any wavelength within the range of 1500 nm to 1600 nm at an angle of incidence from normal to less than 60°. In embodiments, the quantity, thicknesses, and materials of the layers of the outer layered film 36 and inner layered film 38 are configured so that the window 100a, 200a has an S & P polarization transmittance of greater than 65%, greater than 70%, greater than 75%, greater than 80%, greater than 85%, or greater than 90% of electromagnetic radiation having wavelengths within ±25 nm of 905 nm and/or 1550 nm at an angle of incidence from normal to less than 60°.

In embodiments, the quantity, thicknesses, and materials of the layers of the outer layered film 36 and inner layered film 38 are configured to also minimize reflectance of the reflected radiation 28 off of the window 100a, 200a having a wavelength of 905 nm and/or 1550 nm through the window. In embodiments, the quantity, thicknesses, and materials of the layers of the outer layered film 36 and inner layered film 38 are configured to also minimize reflectance of electromagnetic radiation having wavelengths within the range of 1500 nm to 1600 nm off of the window 100a, 200a. In embodiments, the quantity, thicknesses, and materials of the layers of the outer layered film 36 and inner layered film 38 are configured so that the window 100a, 200a has an average reflectance of less than 10%, less than 5%, less than 3%, less than 2%, less than 1%, less than 0.8%, less than 0.5%, or even less than 0.3% of electromagnetic radiation having a wavelength of 905 nm and/or 1550 nm at any angle of incidence within the ranges of 0° to 8°, 0 to 15°, 0 to 25°, or even 0° to 50°. In embodiments, the quantity, thicknesses, and materials of the layers of the outer layered film 36 and inner layered film 38 are configured so that the window 100a, 200a has an average reflectance of less than 10%, less than 5%, less than 3%, less than 2%, less than 1%, less than 0.8%, less than 0.5%, or even less than 0.3% of electromagnetic radiation within ±25 nm of at least one wavelength within the range of 900 nm to 1600 nm at any angle of incidence within the ranges of 0° to 8°, 0 to 15°, 0 to 25°, or even 0° to 50°. In embodiments, the quantity, thicknesses, and materials of the layers of the outer layered film 36 and inner layered film 38 are configured so that the window 100a, 200a has an average reflectance of less than 10%, or less than 5%, of electromagnetic radiation having wavelengths of 905 nm and/or 1550 nm at any angle of incidence within the ranges of 0° to 8°, 0 to 15°, or even 0 to 25°. The term “reflectance” is similarly defined as the percentage of incident optical power within a given wavelength range that is reflected from a material (e.g., the window 100a, 200a, the substrate 30, the outer layered film 36, or portions thereof).

In embodiments, the quantity, thicknesses, and materials of the layers of the outer layered film 36 and inner layered film 38 are additionally configured to: (a) minimize transmittance through the window 100a, 200a of, (b) maximize reflectance off of the window 100a, 200a; and/or (c) absorb electromagnetic radiation having wavelengths within the ultraviolet range and the visible spectrum, such as wavelengths within or throughout the ranges of 100 nm to 700 nm, 300 nm to 600 nm, 420 nm to 650 nm, 300 nm to 650 nm, and 300 nm to 700 nm. In embodiments, the quantity, thicknesses, and materials of the layers of the outer layered film 36 and inner layered film 38 are additionally configured to: (a) minimize transmittance through the window 100a, 200a; (b) maximize reflectance off of the window 100a, 200a; and/or (c) absorb electromagnetic radiation having wavelengths within the ultraviolet range, the visible spectrum, and portions of the infrared range shorter than 1500 nm or shorter than 850 nm, such as wavelengths within the ranges of 300 nm to 850 nm, 300 nm to 900 nm, or 300 nm to 1500 nm. In embodiments, the quantity, thicknesses, and materials of the layers of the outer layered film 36 and the inner layered film 38 are additionally configured so that the window 100a, 200a has an average transmittance of less than 10%, less than 5%, less than 3%, less than 2%, less than 1%, less than 0.8%, less than 0.5%, less than 0.2%, or even less than 0.15% of electromagnetic radiation in the ultraviolet and/or visible spectra having a wavelength within the ranges of 100 nm to 700 nm, 300 nm to 600 nm, 300 nm to 650 nm, 420 nm to 650 nm, 300 nm to 700 nm, or 300 nm to 950 nm, at normal or near normal incidence (i.e., <15° incidence). In embodiments, the quantity, thicknesses, and materials of the layers of the outer layered film 36 and inner layered film 38 are additionally configured so that the window 100a, 200a has an average reflectance of more than 80%, or more than 90%, more than 95%, or even more than 97%, over any incident angle within the range of 0° to 8°, 0° to 15°, or 0° to 25° for electromagnetic radiation having any wavelength within the ultraviolet range and the visible spectrum, such as wavelengths within the ranges of 300 nm to 600 nm, 300 nm to 650 nm, 420 nm to 650 nm, 300 nm to 700 nm, 300 nm to 950 nm, 400 nm to 700 nm, 500 nm to 700 nm, or 550 nm to 700 nm. These embodiments prevent or lessen transmittance of temperature increasing sunlight through the window 100a, 200a to the enclosure 20 of the LIDAR system 12, which improves performance of the LIDAR system 12. In addition, these embodiments prevent or lessen transmittance of the electromagnetic radiation of wavelengths unnecessary to the operation of the LIDAR system 12, such as wavelengths outside of the range of 1450 nm to 1550 nm (or 850 nm to 950 nm, and 1450 nm and 1550 nm), which reduces noise interfering with the electromagnetic radiation emitter and sensor 18 and thus improves performance of the LIDAR system 12.

As mentioned above, amorphous silicon (a-Si) is an especially suitable material for use as one or more of the absorption layers 60, in some implementations, as substituted for one or more high refractive index layers 40. In addition to having a relatively high refractive index (approximately 3.77 at 1550 nm), amorphous silicon (a-Si) has a relatively high optical absorption in the ultraviolet range and visible light range, but tolerable optical absorption in the range of 900-1800 nm. The thicknesses and quantity of absorption layers 60 of amorphous silicon (a-Si), along with the other layers of the outer layered film 36 and inner layered film 38 can thus provide a window 100a, 200a with low percentage transmittance of electromagnetic radiation in the ultraviolet range and visible light range (due in part to the optical absorbance of the amorphous silicon at those wavelength ranges) but high percentage transmittance in the desired portions of the infrared range. Embodiments not utilizing amorphous silicon (a-Si), or some other material with similar optical absorbance properties, may utilize primarily optical interference to provide the window 100a, 200a with the desired optical properties (e.g., low transmittance and/or high reflectance in the range of 300 nm to 700 nm but high transmittance and low reflectance at 1550 nm or some range including 1550 nm). The examples below and other embodiments that do utilize amorphous silicon (a-Si) or some other material with similar optical absorbance properties for the absorption layers 60 utilize optical absorbance and optical interference to provide the window 100a, 200a with the desired optical properties. Thus, embodiments utilizing absorption layers 60 of amorphous silicon (a-Si) or some other material with similar optical absorbance properties can provide the window 100a, 200a with the desired optical properties with less layers in the outer layered film 36 and inner layered film 38 than embodiments not utilizing amorphous silicon (a-Si) or some other material with similar optical absorbance properties. In embodiments, the inner layered film 38 includes one or more absorption layers 60 of amorphous silicon (a-Si) as one of the one or more high refractive index layers 40 while the outer layered film 36 does not.

More generally, the quantity, thicknesses and materials of the outer and inner layered films 36, 38, can be configured to tune to the reflected color of the window 100a, 200a at an angle of incidence of less than 90°, as depicted in exemplary form in FIGS. 4A-5B. In some embodiments of the window 100a, 200a, the quantity, thicknesses and materials of the outer and inner layered films 36, 38, are configured such that the window as viewed from the outer layered film 36 exhibits a tunable, reflected color at an angle of incidence of less than 90°, or less than 15°, as given by CIE color coordinates with a* from +50 to 0 and b* from +40 to 0. In some embodiments of the window 100a, 200a, the quantity, thicknesses and materials of the outer and inner layered films 36, 38, are configured such that the window as viewed from the inner layered film 38 exhibits a tunable, reflected color at an angle of incidence of less than 90°, or less than 15°, as given by CIE color coordinates with a* from +10 to −10 and b* from +30 to −10.

Further, the layers of the outer layered film 36 and the inner layered film 38 (e.g., layers of the high refractive index layers 40 and the low refractive index layers 42) may be formed by any known method in the art, including discrete sputter deposition or continuous deposition processes. In one or more embodiments, the layers of the layered films 36, 38 may be formed using only continuous deposition processes, or, alternatively, only discrete deposition processes.

### EXAMPLES

The following examples are all modeled examples using computer facilitated modeling to demonstrate how the quantity, thicknesses, and materials of the layers of the outer layered film 36 and the inner layered film 38 can be configured so that the window 100a, 200a has a desired average transmittance and average reflectance as a function of the wavelength and angle of incidence of the incident electromagnetic radiation, among the other properties and attributes outlined in this disclosure.

The refractive indices (n) and optical absorbance (k), as a function of wavelength, of each of the alternating high refractive index layers 40 and low refractive index layers 42 of the outer layered film 36, inner layered film 38, and the substrate 30, were measured using spectroscopic ellipsometry. The refractive indices for SiNₓ, SiO₂, amorphous silicon (a-Si), In₂O₃-doped ZnO₂ (IZO), and an aluminosilicate glass substrate (Corning® Gorilla® Glass 3) for Examples 1 and 2 are provided in the Tables 1 and 2 below, respectively. Those materials are utilized in the following examples as the high refractive index layers 40, the low refractive index layers 42, absorption layers 60, transparent conductive oxide layers 70, and the substrate 30.

### Example 1

In this example, a two-sided cover window configuration exemplary of window 200a (see FIGS. 5A and 5B, and corresponding description above) is modeled and detailed below in Table 1. This example window design enables >80% transmission in the infrared wavelength range of 1550 nm±25 nm for normal and up to 60° angles of incidence, <0.5% reflection in the infrared wavelength range of 1550 nm±25 nm for a normal angle of incidence, <<10% transmission in the visible wavelength range for a normal angle of incidence, >11 GPa Berkovich nanoindentation hardness within the outer layered film (e.g., an outer layered film 36) at an indentation depth in the range from about 50 nm to about 1000 nm, and >15 dB of attenuation for microwave radiation.

TABLE 1
Example 1

| | | | | Corresponding |
|---|---|---|---|---|
| | | Refractive | Thickness | layer of |
| Layer | Material | Index | (nm) | window 200a |
| | Air | 1 | | |
| | Perfluoropolyether | ~1.4 | ~4-8 | |
| 1 | SiO₂ | 1.46349 | 261.03 | 42 |
| 2 | SiNₓ | 2.01269 | 233.6 | 40 |
| 3 | SiO₂ | 1.46349 | 413.36 | 42 |
| 4 | SiNₓ | 2.01269 | 193.17 | 40 |
| 5 | Si | 3.74413 | 47.37 | 60 |
| 6 | SiO₂ | 1.46349 | 89.16 | 42 |
| 7 | Si | 3.74413 | 28.86 | 60 |
| 8 | SiNₓ | 1.98699 | 2000 | 40/52 |
| 9 | SiO₂ | 1.46349 | 76.89 | 42 |
| 10 | SiNₓ | 2.01269 | 78.18 | 40 |
| 11 | SiO₂ | 1.46349 | 25 | 42 |
| 12 | Corning ® Gorilla ® | 1.49975 | 2 mm | 30 |
| | Glass 3 | | | |
| | (non-chemically | | | |
| | strengthened) | | | |
| 13 | IZO | 1.62471 | 145 | 70 |
| 14 | SiO₂ | 1.46349 | 622.02 | 42 |
| 15 | Si | 3.84504 | 24.69 | 40/60 |
| 16 | SiO₂ | 1.46349 | 128.94 | 42 |
| 17 | Si | 3.84504 | 58.03 | 40/60 |
| 18 | SiO₂ | 1.46349 | 160.39 | 42 |
| 19 | Si | 3.84504 | 25.23 | 40/60 |
| 20 | SiO₂ | 1.46349 | 249.98 | 42 |
| 21 | Si | 3.84504 | 196.45 | 40/60 |
| 22 | SiO₂ | 1.46349 | 211.19 | 42 |
| | Air | 1 | | |

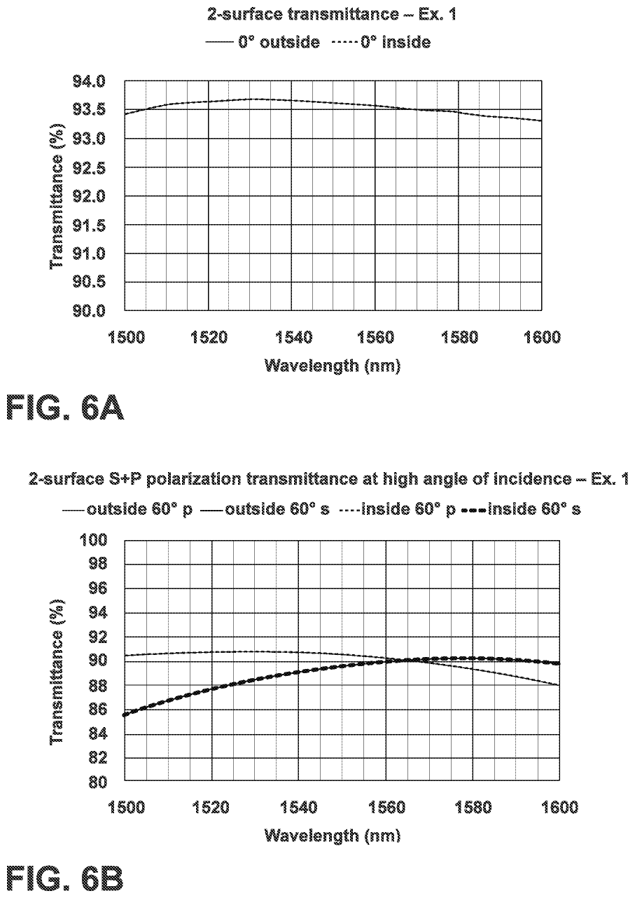

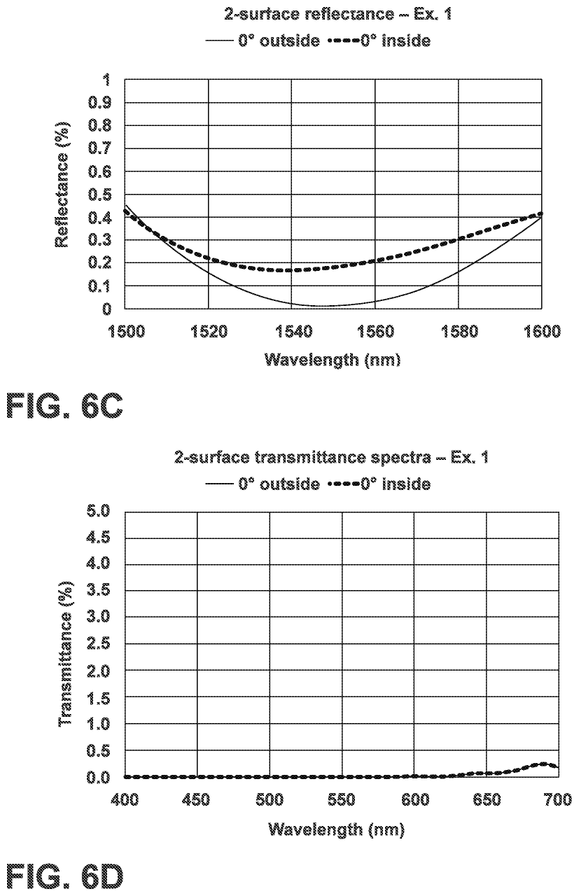

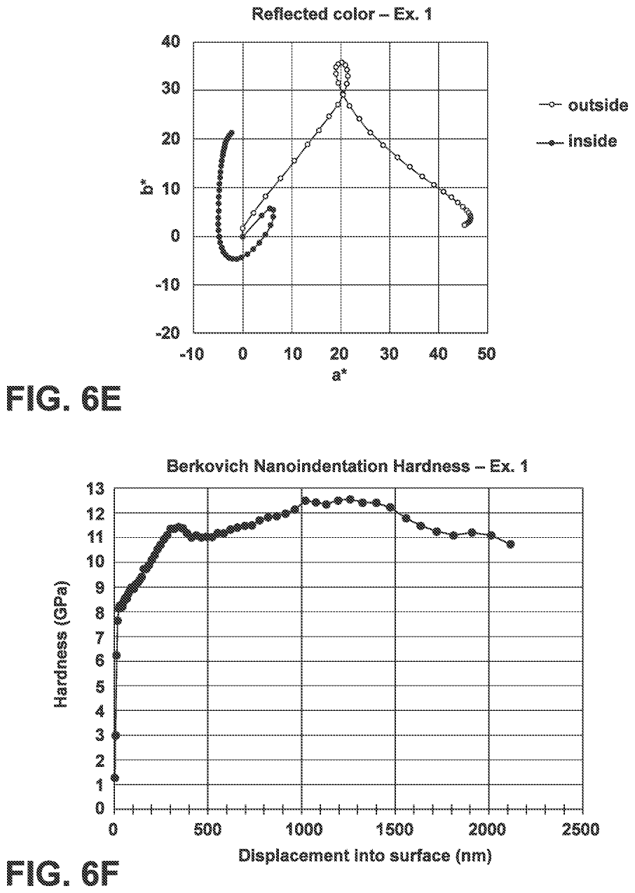

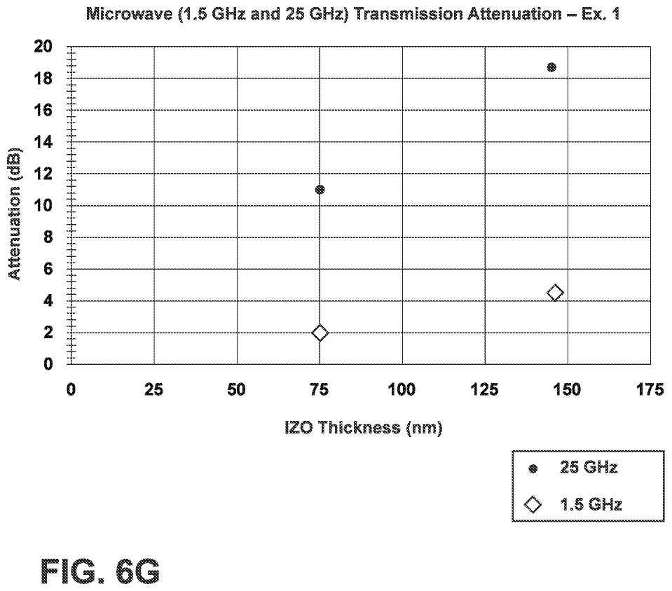

Referring to FIG. 6A, a chart is provided of modeled two-surface transmittance vs. wavelength for the exemplary window of Example 1, as measured from 1500 nm to 1600 nm at normal incidence from the outside and inside surfaces of the window. As shown in FIG. 6A, the window of Example 1 exhibits >90% transmittance over the wavelength range of 1550 nm±25 nm.

Referring to FIG. 61B, a chart is provided of modeled two-surface S & P polarization transmittance vs. wavelength for the exemplary window of Example 1, as measured from 1500 nm to 1600 nm at 60° incidence from the outside and inside surfaces of the window. As shown in FIG. 6B, the window of Example 1 exhibits >85% S & P polarization transmittance over the wavelength range of 1550 nm±25 nm.

Referring now to FIG. 6C, a chart is provided of modeled two-surface reflectance vs. wavelength for the exemplary window of Example 1, as measured from 1500 nm to 1600 nm at normal incidence from the outside and inside surfaces of the window. As shown in FIG. 6C, the window of Example 1 exhibits <0.3% reflectance over the wavelength range of 1550 nm±25 nm.

Referring now to FIG. 6D, a chart is provided of modeled two-surface transmittance vs. wavelength for the exemplary window of Example 1, as measured from 400 nm to 700 nm at normal incidence from the outside and inside surfaces of the window. As shown in FIG. 6D, the window of Example 1 exhibits <10% transmission over the visible wavelength range.

Referring now to FIG. 6E, a chart is provided of modeled reflected color for the exemplary window of Example 1, as measured from normal to 90° degrees incidence from the outside and inside surfaces of the window. As show, when viewed from the outer layered film 36, the window according to Example 1 exhibited a* values ranging from 0 to about 46 and b* values ranging from about 1 to about 36. When viewed from the inner layered film 38, the window according to Example 1 exhibited a* values ranging from about −7 to about 7 and b* values ranging from about −4 to about 21. As is evident from FIG. 6E, the configuration of the layers of the window can be adjusted to tune the reflected color exhibited by the window.

Referring now to FIG. 6F, a chart is provided of measured Berkovich nanoindentation hardness vs. displacement into the outer surface of an exemplary window that is fabricated according to Example 1. As is evident from FIG. 6F, the window exhibits >11 GPa nanoindentation hardness beyond a 500 nm displacement depth. Moreover, the window exhibits a maximum nanoindentation hardness of greater than 12 GPa. The nanoindentation hardness is greater than 10 GPa over a depth range of 200 nm to 2100 nm.

Referring now to FIG. 6G, a chart is provided of measured attenuation of microwave radiation through exemplary windows of the disclosure consistent with Example 1 vs. thickness of the indium zinc oxide layer (i.e., its transparent conductive oxide layer 70) within these windows. As is evident from FIG. 6G, the windows of this example exhibit >15 dB attenuation at 25 GHz when employing a 145 nm thick TCO layer of IZO material. Also, the windows of this example exhibit >4 dB attenuation at 1.5 GHz when employing a 145 nm thick TCO layer of IZO material. As is also evident from FIG. 6G, lower, but appreciable, levels of attenuation are observed for windows employing a 75 nm thick TCO layer of IZO material.

Referring again to FIGS. 6A-6G, windows with thicker TCO layers (e.g., as made of IZO material) will have higher attenuation at all wavelengths (i.e., in the collective visible, infrared and microwave wavelength regimes) and thinner TCO layers will have relatively lower levels of attenuation. Nevertheless, the ratios of transmittance in each of the visible, infrared, and microwave wavelength regimes are primarily influenced by the material properties of the TCO layer, resulting in relatively higher transmission in the visible and infrared wavelength regimes as compared to the microwave wavelength regime. Put another way, spectral attenuation associated with the TCO layer increases with increasing wavelength. As such, the absorption in the windows of the disclosure in the visible regime is less than the absorption in the infrared regime (i.e., at 1550 nm). At longer wavelengths than 1550 nm, the attenuation associated with the TCO layer increases, which is one of the main drivers of the microwave shielding afforded by the windows of the disclosure.

### Example 2

In this example, a two-sided window configuration exemplary of window 100a (see FIGS. 4A and 4B, and corresponding description above) is modeled and detailed below in Table 2. This example window design enables >99% transmission and <0.1% reflection in the infrared wavelength range of 1550 nm±25 nm for a normal angle of incidence, <<10% transmission in the visible wavelength range for a normal angle of incidence, and >14 GPa Berkovich nanoindentation hardness at the outer surface.

TABLE 2
Example 2

| | | | | Corresponding |
|---|---|---|---|---|
| | | Refractive | Thickness | layer of |
| Layer | Material | Index | (nm) | window 100a |
| | Air | 1 | | |
| | Perfluoropolyether | ~1.4 | ~4-8 | |
| 1 | SiO₂ | 1.46349 | 190.3 | 42 |
| 2 | SiNₓ | 2.01269 | 280.0 | 40 |
| 3 | SiO₂ | 1.46349 | 413.3 | 42 |
| 4 | SiNₓ | 2.01269 | 289.4 | 40 |
| 5 | SiO₂ | 1.46349 | 488.9 | 42 |
| 6 | SiNₓ | 2.01269 | 580.3 | 40 |
| 7 | SiO₂ | 1.46349 | 8.0 | 42 |
| 8 | SiNₓ | 1.98699 | 2000 | 40/52 |
| 9 | SiO₂ | 1.46349 | 43.6 | 42 |
| 10 | SiNₓ | 2.01269 | 137.6 | 40 |
| 11 | SiO₂ | 1.46349 | 130.4 | 42 |
| 12 | SiNₓ | 2.01269 | 57.1 | 40 |
| 13 | SiO₂ | 1.46349 | 556.0 | 42 |
| 14 | Corning ® Gorilla ® | 1.49975 | 2 mm | 30 |
| | Glass 3 | | | |
| | (non-chemically | | | |
| | strengthened) | | | |
| 15 | SiO₂ | 1.46349 | 330.4 | 42 |
| 16 | Si | 3.84504 | 222.6 | 40/60 |
| 17 | SiO₂ | 1.46349 | 91.6 | 42 |
| 18 | Si | 3.84504 | 144.7 | 40/60 |
| 19 | SiO₂ | 1.46349 | 37.8 | 42 |
| 20 | SiNₓ | 2.01269 | 130.2 | 40 |
| 21 | SiO₂ | 1.46349 | 240.9 | 42 |
| 22 | SiNₓ | 2.01269 | 199.0 | 40 |
| 23 | SiO₂ | 1.46349 | 434.0 | 42 |
| 24 | SiNₓ | 2.01269 | 279.9 | 40 |
| 25 | SiO₂ | 1.46349 | 365.3 | 42 |
| 26 | SiNₓ | 2.01269 | 287.4 | 40 |
| 27 | SiO₂ | 1.46349 | 142.8 | 42 |
| | Air | 1 | | |

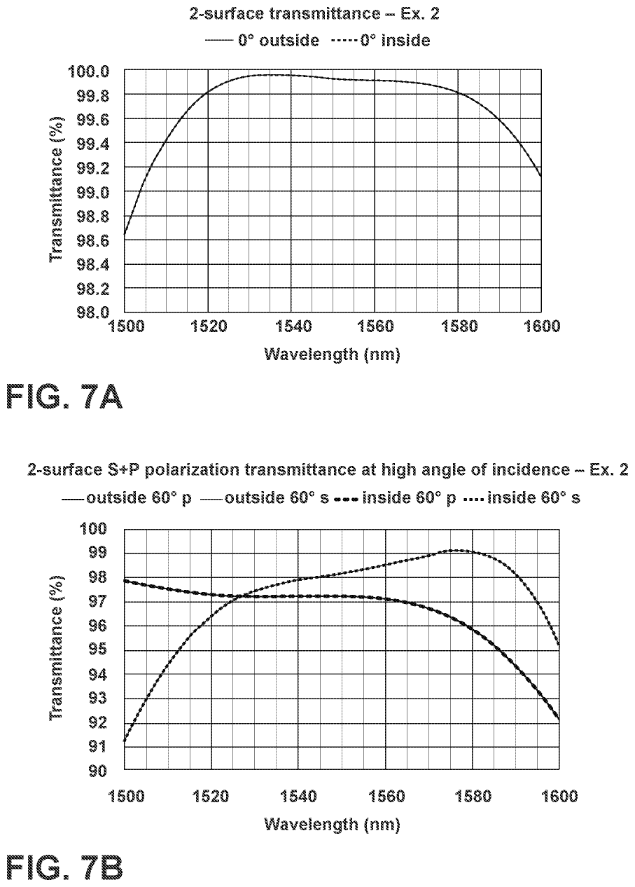

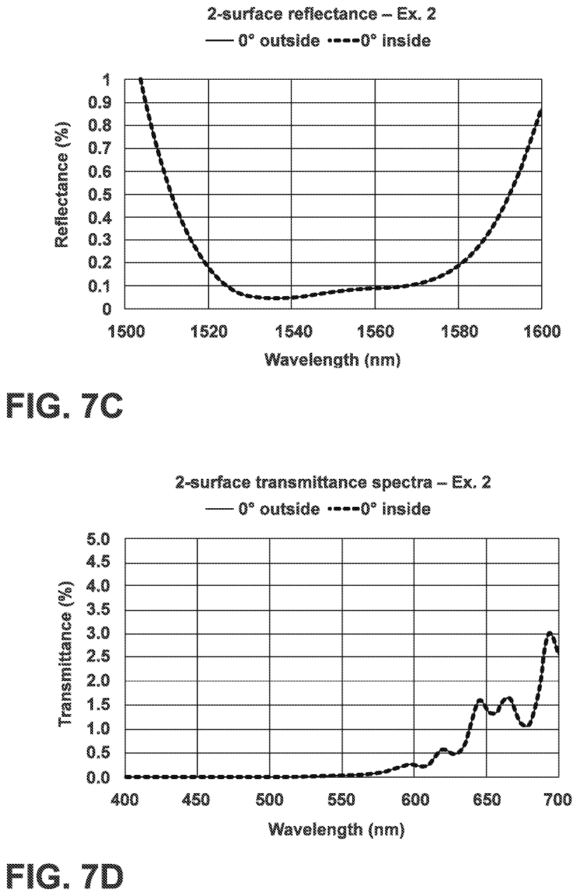

Referring now to FIG. 7A, a chart is provided of modeled two-surface transmittance vs. wavelength for an exemplary window of Example 2, as measured from 1500 nm to 1600 nm at normal incidence from the outside and inside surfaces of the window. As is evident from FIG. 7A, the window of Example 2 exhibits >99.8% transmittance over the wavelength range of 1550 nm±25 nm.

Referring now to FIG. 7B, a chart is provided of modeled two-surface S & P polarization transmittance vs. wavelength for an exemplary window of Example 2, as measured from 1500 nm to 1600 nm at 60° incidence from the outside and inside surfaces of the window. As shown in FIG. 7B, the window of Example 2 exhibits >91% S & P polarization transmittance over the wavelength range of 1550 nm±25 nm.

Referring now to FIG. 7C, a chart is provided of modeled two-surface reflectance vs. wavelength for an exemplary window of Example 2, as measured from 1500 nm to 1600 nm at normal incidence from the outside and inside surfaces of the window. As shown in FIG. 7C, the window of Example 2 exhibits <0.15% reflectance over the wavelength range of 1550 nm±25 nm.

Referring now to FIG. 7D, a chart is provided of modeled two-surface transmittance vs. wavelength for an exemplary window of Example 2, as measured from 400 nm to 700 nm at normal incidence from the outside and inside surfaces of the window. As shown in FIG. 7D, the window of Example 2 exhibits <<10% (more specifically, less than 3.5%) transmission over the visible wavelength range.

### Example 3

In this example, a two-sided cover window configuration exemplary of window 200a (see FIGS. 5A and 5B, and corresponding description above) is modeled and detailed below in Table 3. This example window design enables >90% transmission in the infrared wavelength range of 1550 nm±25 nm for normal and up to 60° angles of incidence, <0.5% reflection in the infrared wavelength range of 1550 nm±25 nm for a 15° angle of incidence, <12% transmission in the visible wavelength range for a 15° angle of incidence, >11 GPa Berkovich nanoindentation hardness within the outer layered film (e.g., an outer layered film 36) at an indentation depth in the range from about 50 nm to about 1000 nm, and >15 dB of attenuation for microwave radiation.

The Example 3 includes a transparent conductive oxide layer 70 in the inner layered film 38. As shown in Table 3, unlike in Example 1, the transparent conductive oxide layer 70 does not directly contact the substrate 30. Instead, one of the one or more low refractive index layers 42 is positioned between the substrate 30 and the transparent conductive oxide layer 70. Incorporating this low index layer adjacent the substrate 30 is believed to improve adhesion of the transparent conductive oxide layer 70 and aid in durability. Another difference with Example 1 is that the outer layered film 36 does not include any of the absorption layers 60. The outer layered film 36 comprises alternating layers of SiO₂ and SiN, with SiO₂ layers forming the outer and inner most layers of the outer layered film 36, respectively. It is believed that not including any absorption layers in the outer layered film 36 increases hardness (and therefore scratch resistance and durability) and reduces delamination risk over the structure in Example 1. The final 9 layers of the inner layered film 38 in Example 3 are alternating low index layers 42 and absorber layers 60. As a result, the only high index layers 40 present in the inner layered film 38 are between the transparent conductive oxide layer 70 and one of the absorber layers 60 most proximate to the substrate 30. Such multiple absorber layers facilitates absorbance in the visible spectrum and a desired appearance.

The transparent conductive oxide layer 70 included in the inner layered film 38 in Example 3 was 95 nm, which was based on a targeted sheet resistance of 70 ohm/sq. This is less than the 140 nm thickness used in Example 1, which targeted the same sheet resistance. In embodiments, the transparent conductive oxide layer 70 incorporated into one of the inner layered film 38 and the outer layered film 36 comprises a sheet resistance that is greater than or equal to 50 ohm/sq and less than or equal to 100 ohm/sq (e.g., greater than or equal to 60 ohm/sq and less than or equal to 90 ohm/sq) to provide suitable amount of energy attenuation.

Example 3 is further different from Example 1 in that Example 3 contains silicon that has a lower extinction coefficient than that used in Example 1. Example 1 utilized a more conventional silicon having an extinction coefficient of greater than 0.05 at 1550 nm. Example 3, in contrast, utilized silicon in the inner layered film 38 with an extinction coefficient of less than 0.01 (e.g., less than or equal to 0.003). Example 3 also includes a 2000 nm thick scratch resistance layer 52 in the outer layered film 36 having a higher refractive index (greater than 2.0 at 1550 nm) than that used in Example 1. This high index SiN layer is expected to have a higher hardness. As a result of incorporating the low extinction coefficient Si and the thinner transparent conductive oxide layer 70, Example 3 was found to exhibit an improved transmission performance over Example 1 (Example 3 exhibited approximately 96.3% transmittance for light at a 15° angle of incidence).

TABLE 3
Example 3

| | | Refractive | Extinction | | Corresponding |
|---|---|---|---|---|---|
| | | Index at | Coefficient | Thickness | layer of |
| Layer | Material | 1550 nm | at 1550 nm | (nm) | window 200a |
| | Air | 1 | | | |
| | Perfluoropolyether | ~1.4 | | ~4-8 | |
| 1 | SiO₂ | 1.45723 | 0 | 209.19 | 42 |
| 2 | SiN | 2.04658 | 0 | 269.78 | 40 |
| 3 | SiO₂ | 1.45723 | 0 | 416.82 | 42 |
| 4 | SiN | 2.04658 | 0 | 294.12 | 40 |
| 5 | SiO₂ | 1.45723 | 0 | 482.62 | 42 |
| 6 | SiN | 2.04658 | 0 | 2000.00 | 40/52 |
| 7 | SiO₂ | 1.45723 | 0 | 150.20 | 42 |
| 8 | SiN | 2.04658 | 0 | 73.55 | 40 |
| 9 | SiO₂ | 1.45723 | 0 | 262.40 | 42 |
| 10 | SiN | 2.04658 | 0 | 42.35 | 40 |
| 11 | SiO₂ | 1.45723 | 0 | 25.00 | 42 |
| 12 | Corning ® Gorilla ® | 1.49975 | | 2 mm | 30 |
| | Glass 3 | | | | |
| | (non-chemically | | | | |
| | strengthened) | | | | |
| 13 | SiO₂ | 1.45723 | 0 | 25.00 | 42 |
| 14 | IZO | 1.65652 | 0.04192 | 95.00 | 70 |
| 15 | SiO₂ | 1.45723 | 0 | 181.60 | 42 |
| 16 | SiN | 2.04658 | 0 | 78.90 | 40 |
| 17 | SiO₂ | 1.45723 | 0 | 319.57 | 42 |
| 18 | SiN | 2.04658 | 0 | 246.14 | 40 |
| 19 | SiO₂ | 1.45723 | 0 | 22.75 | 42 |
| 20 | Si | 3.47334 | 0 | 67.46 | 40/60 |
| 21 | SiO₂ | 1.45723 | 0 | 194.59 | 42 |
| 22 | Si | 3.47334 | 0 | 61.48 | 40/60 |
| 23 | SiO₂ | 1.45723 | 0 | 54.94 | 42 |
| 24 | Si | 3.47334 | 0 | 140.14 | 40/60 |
| 25 | SiO₂ | 1.45723 | 0 | 467.51 | 42 |
| 26 | Si | 3.47334 | 0 | 196.39 | 40/60 |
| 27 | SiO₂ | 1.45723 | 0 | 210.87 | 42 |
| | Air | 1 | | | |

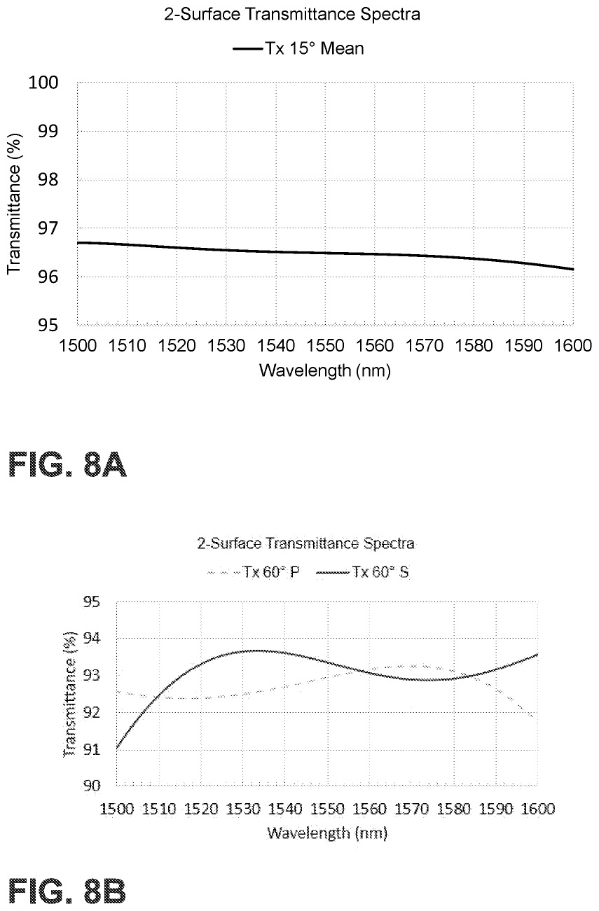

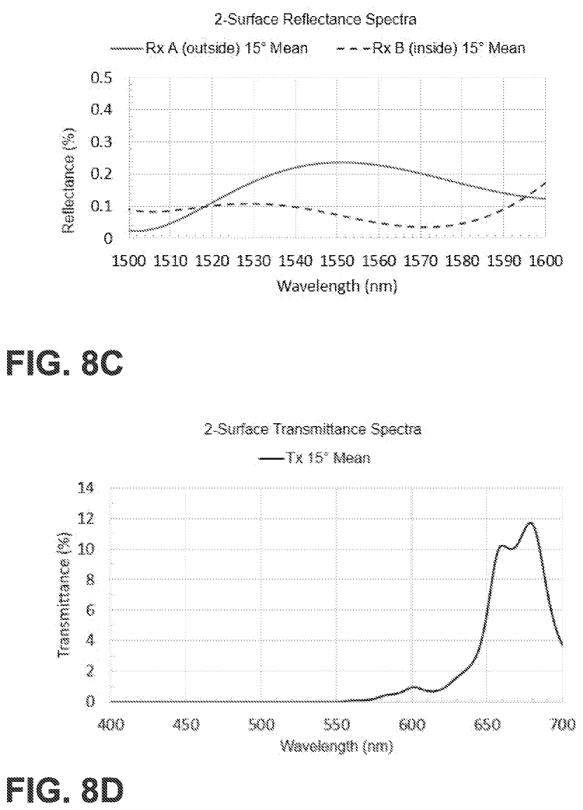

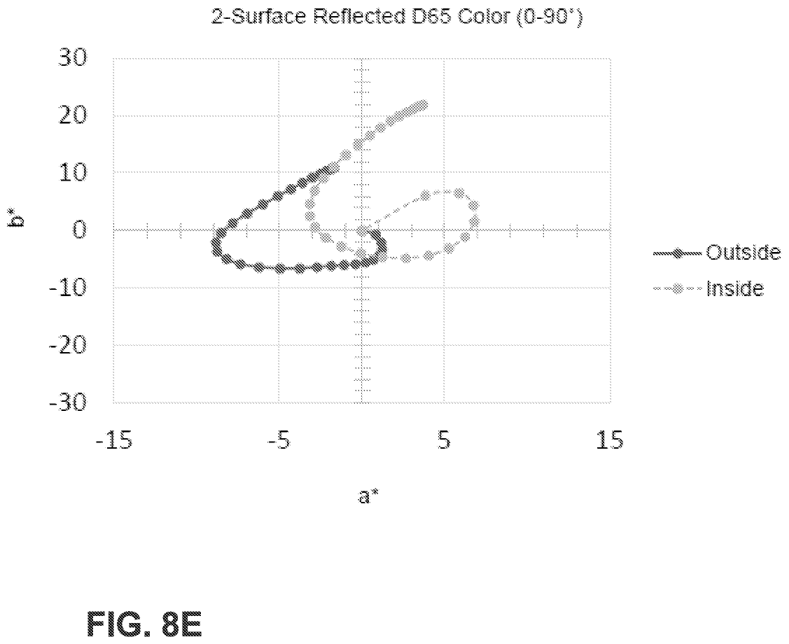

Referring to FIG. 8A, a chart is provided of modeled two-surface transmittance vs. wavelength for the exemplary window of Example 3, as measured from 1500 nm to 1600 nm at an angle of incidence of 15′ from the outside and inside surfaces of the window (mean polarization). As shown in FIG. 8A, the window of Example 3 exhibits >95% (even >96%) transmittance over the wavelength range of 1550 nm±25 nm, an improvement over Example 1.

Referring to FIG. 8B, a chart is provided of modeled two-surface S & P polarization transmittance vs. wavelength for the exemplary window of Example 3, as measured from 1500 nm to 1600 nm at a 60° angle of incidence from the outside and inside surfaces of the window. As shown in FIG. 8B, the window of Example 3 exhibits >91% S & P polarization transmittance over the wavelength range of 1550 nm±25 nm, an improvement over Example 1.

Referring now to FIG. 8C, a chart is provided of modeled two-surface reflectance vs. wavelength for the exemplary window of Example 3, as measured from 1500 nm to 1600 nm at a 15° angle of incidence from the outside and inside surfaces of the window. As shown in FIG. 8C, the window of Example 3 exhibits <0.3% reflectance over the wavelength range of 1550 nm±25 nm, irrespective of polarization.

Referring now to FIG. 8D, a chart is provided of modeled two-surface transmittance vs. wavelength for the exemplary window of Example 3, as measured from 400 nm to 700 nm at an angle of incidence of 15° from the outside and inside surfaces of the window. As shown in FIG. 8D, the window of Example 1 exhibits <12% transmission over the visible wavelength range. Particularly, at wavelengths less than 625 nm, the window exhibits a transmittance of less than 1%. An average transmittance is less than 10% over the wavelength range from 400 nm to 700 nm at the 15° angle of incidence.

Referring now to FIG. 8E, a chart is provided of modeled reflected color for the exemplary window of Example 3, as measured from normal to 90° degrees incidence from the outside and inside surfaces of the window. As show, when viewed from the outer layered film 36, the window according to Example 3 exhibited a* values ranging from about −9 to about 2 and b* values ranging from about −8 to about 12. When viewed from the inner layered film 38, the window according to Example 3 exhibited a* values ranging from about −3.8 to about 6.8 and b* values ranging from about −5 to about 23. As is evident from FIG. 8E, the configuration of the layers of the window can be adjusted to tune the reflected color exhibited by the window.

According to Aspect 1 of the present disclosure, a window for a sensing system is provided that includes: a substrate comprising an outer primary surface and an inner primary surface, wherein the outer and inner primary surfaces are opposite of one another; an outer layered film disposed on the outer primary surface of the substrate; and an inner layered film disposed on the inner primary surface of the substrate. The outer layered film comprises a plurality of alternating high index and low index layers. The inner layered film comprises a plurality of alternating high index and low index layers. Each of the high index layers has a refractive index greater than a refractive index of each of the low index layers. The outer layered film comprises a scratch resistant layer having a thickness from about 0.5 μm to about 10 μm. The outer layered film exhibits a hardness of at least 11 GPa, as measured with a Berkovich Indenter Hardness Test from the outermost surface of the outer layered film to a depth of 1 μm. Further, the quantity, thicknesses and materials of the plurality of alternating high index and low index layers of the outer layered film and the inner layered film are configured so that the window exhibits an average transmittance of greater than 85% within 25 nm of at least one wavelength within the infrared spectrum from 900 nm to 1600 nm at an angle of incidence<15° and an average transmittance of less than 5% in the visible spectrum from 420 nm to 650 nm at an angle of incidence<15°.

According to Aspect 2 of the present disclosure, Aspect 1 is provided, wherein a low index layer in the outer layered film and the inner layered film is in contact with the outer and inner primary surfaces of the substrate, respectively.

According to Aspect 3 of the present disclosure, Aspect 1 or Aspect 2 is provided, wherein each of the high index layers comprises a silicon-containing nitride, a silicon-containing oxynitride, an aluminum-containing nitride or an aluminum-containing oxynitride.

According to Aspect 4 of the present disclosure, any one of Aspects 1-3 is provided, wherein each of the low index layers comprises a silicon-containing oxide.

According to Aspect 5 of the present disclosure, any one of Aspects 1-4 is provided, wherein the plurality of alternating high index and low index layers in the outer layered film is from five (5) to fifteen (15) layers.

According to Aspect 6 of the present disclosure, any one of Aspects 1-5 is provided, wherein the plurality of alternating high index and low index layers in the inner layered film is from five (5) to fifteen (15) layers.

According to Aspect 7 of the present disclosure, any one of Aspects 1-6 is provided, wherein the quantity, thicknesses and materials of the plurality of alternating high index and low index layers of the outer layered film and the inner layered film are configured so that the window exhibits a transmittance of greater than 99% for the infrared wavelength of 1550 nm±25 nm at normal incidence.

According to Aspect 8 of the present disclosure, any one of Aspects 1-7 is provided, wherein the scratch resistant layer has a thickness from 1 μm to 10 μm, and the outer layered film exhibits a hardness of at least 14 GPa, as measured with a Berkovich Indenter Hardness Test from the outermost surface of the outer layered film to a depth of 1 μm.

According to Aspect 9 of the present disclosure, a window for a sensing system is provided that includes: a substrate comprising an outer primary surface and an inner primary surface, wherein the outer and inner primary surfaces are opposite of one another; an outer layered film disposed on the outer primary surface of the substrate; and an inner layered film disposed on the inner primary surface of the substrate. The outer layered film comprises a plurality of alternating high index and low index layers. The inner layered film comprises a plurality of alternating high index and low index layers. Each of the high index layers has a refractive index greater than a refractive index of each of the low index layers. The outer layered film comprises a scratch resistant layer having a thickness from about 0.5 μm to about 10 μm. Further, the inner layered film comprises one or more absorption layers, wherein each absorption layer comprises a refractive index of 3.0 or greater and an extinction coefficient of 0.1 or greater at one or more wavelengths in the ultraviolet and visible spectra from 100 nm to 700 nm. The outer layered film exhibits a hardness of at least 11 GPa, as measured with a Berkovich Indenter Hardness Test from the outermost surface of the outer layered film to a depth of 1 μm. Further, the quantity, thicknesses and materials of the plurality of alternating high index and low index layers of the outer layered film and the inner layered film are configured so that the window exhibits an average transmittance of greater than 85% within ±25 nm of at least one wavelength within the infrared spectrum from 900 nm to 1600 nm at an angle of incidence<15° and an average transmittance of less than 5% in the visible spectrum from 420 nm to 650 nm at an angle of incidence<15°.

According to Aspect 10 of the present disclosure, Aspect 9 is provided, wherein the one or more absorption layers are selected from the group consisting of amorphous silicon (a-Si), germanium (Ge) and gallium arsenide (GaAs), and further wherein none of the one or more absorption layers are in direct contact with the inner primary surface of the substrate.

According to Aspect 11 of the present disclosure, Aspect 9 or Aspect 10 is provided, wherein the one or more of the high index layers of the inner layered film are the one or more absorption layers.

According to Aspect 12 of the present disclosure, any one of Aspects 9-11 is provided, wherein the one or more absorption layers are amorphous silicon (a-Si).

According to Aspect 13 of the present disclosure, any one of Aspects 9-12 is provided, wherein the quantity, thicknesses and materials of the plurality of alternating high index and low index layers of the outer layered film and the inner layered film are configured so that the window exhibits a transmittance of less than 10% in the visible spectrum from 420 nm to 700 nm at normal incidence.

According to Aspect 14 of the present disclosure, any one of Aspects 9-13 is provided, wherein the plurality of alternating high index and low index layers in the outer layered film is from five (5) to fifteen (15) layers.

According to Aspect 15 of the present disclosure, any one of Aspects 9-14 is provided, wherein the plurality of alternating high index and low index layers in the inner layered film is from five (5) to fifteen (15) layers.

According to Aspect 16 of the present disclosure, any one of Aspects 9-15 is provided, wherein the scratch resistant layer has a thickness from 1 μm to 10 μm, and the outer layered film exhibits a hardness of at least 14 GPa, as measured with a Berkovich Indenter Hardness Test from the outermost surface of the outer layered film to a depth of 1 m.

According to Aspect 17 of the present disclosure, a window for a sensing system is provided that includes: a substrate comprising an outer primary surface and an inner primary surface, wherein the outer and inner primary surfaces are opposite of one another; an outer layered film disposed on the outer primary surface of the substrate; and an inner layered film disposed on the inner primary surface of the substrate. The outer layered film comprises a plurality of alternating high index and low index layers. The inner layered film comprises a plurality of alternating high index and low index layers. Each of the high index layers has a refractive index greater than a refractive index of each of the low index layers. The outer layered film comprises a scratch resistant layer having a thickness from about 0.5 μm to about 10 μm. Further, the inner layered film or the outer layered film comprises a transparent conductive oxide layer. The outer layered film exhibits a hardness of at least 11 GPa, as measured with a Berkovich Indenter Hardness Test from the outermost surface of the outer layered film to a depth of 1 μm. Further, the quantity, thicknesses and materials of the plurality of alternating high index and low index layers of the outer layered film and the inner layered film are configured so that the window exhibits an average transmittance of greater than 85% within ±25 nm of at least one wavelength within the infrared spectrum from 900 nm to 1600 nm at an angle of incidence<15° and an average transmittance of less than 5% in the visible spectrum from 420 nm to 650 nm at an angle of incidence<15°.

According to Aspect 18 of the present disclosure, Aspect 17 is provided, wherein the transparent conductive oxide layer is positioned between the substrate and the scratch resistant layer in the outer layered film.

According to Aspect 19 of the present disclosure, Aspect 17 is provided, wherein the transparent conductive oxide layer is positioned in the inner layered film between the substrate and one of the high or low index layers.

According to Aspect 20 of the present disclosure, any one of Aspects 17-19 is provided, wherein the quantity, thicknesses and materials of the plurality of alternating high index and low index layers of the outer layered film and the inner layered film are further configured so that the window exhibits an energy attenuation of at least 15 dB for microwave radiation of greater than 1 GHz.

According to Aspect 21 of the present disclosure, any one of Aspects 17-20 is provided, wherein a low index layer in the outer layered film is in contact with the outer primary surface of the substrate.

According to Aspect 22 of the present disclosure, any one of Aspects 17-21 is provided, wherein each of the high index layers comprises a silicon-containing nitride, a silicon-containing oxynitride, an aluminum-containing nitride or an aluminum-containing oxynitride.

According to Aspect 23 of the present disclosure, any one of Aspects 17-22 is provided, wherein each of the low index layers comprises a silicon-containing oxide.

According to Aspect 24 of the present disclosure, any one of Aspects 17-23 is provided, wherein the plurality of alternating high index and low index layers in the outer layered film and the inner layered film is from five (5) to fifteen (15) layers.

According to Aspect 25 of the present disclosure, any one of Aspects 17-24 is provided, wherein the scratch resistant layer has a thickness from 1 μm to 10 μm, and the outer layered film exhibits a hardness of at least 14 GPa, as measured with a Berkovich Indenter Hardness Test from the outermost surface of the outer layered film to a depth of 1 M.

According to Aspect 26 of the present disclosure, any one of Aspects 17-25 is provided, wherein at least one of the inner layered film and the outer layered film comprises one or more absorption layers, wherein each absorption layer comprises a refractive index of 3.0 or greater and an extinction coefficient of 0.1 or greater at one or more wavelengths in the ultraviolet and visible spectra from 100 nm to 700 nm.

According to Aspect 27 of the present disclosure, Aspect 26 is provided, wherein the one or more absorption layers are selected from the group consisting of amorphous silicon (a-Si), germanium (Ge) and gallium arsenide (GaAs).

According to Aspect 28, Aspect 26 or Aspect 27 is provided, wherein the one or more of the high index layers of the inner layered film are the one or more absorption layers.

It will be apparent to those skilled in the art that various modifications and variations can be made without departing from the spirit or scope of the claims.

1. A window for a sensing system, comprising:
a substrate comprising an outer primary surface and an inner primary surface, wherein the outer and inner primary surfaces are opposite of one another;
an outer layered film disposed on the outer primary surface of the substrate; and
an inner layered film disposed on the inner primary surface of the substrate,
wherein the outer layered film comprises a plurality of alternating high index and low index layers,
wherein the inner layered film comprises a plurality of alternating high index and low index layers,
wherein each of the high index layers having a refractive index greater than a refractive index of each of the low index layers,
wherein the outer layered film comprises a scratch resistant layer having a thickness from about 0.5 μm to about 10 μm,
wherein the outer layered film exhibits a hardness of at least 11 GPa, as measured with a Berkovich Indenter Hardness Test from the outermost surface of the outer layered film to a depth of 1 μm,
wherein the quantity, thicknesses and materials of the plurality of alternating high index and low index layers of the outer layered film and the inner layered film are configured so that the window exhibits an average transmittance of greater than 85% within 25 nm of at least one wavelength within the infrared spectrum from 900 nm to 1600 nm at an angle of incidence<15° and an average transmittance of less than 5% in the visible spectrum from 420 nm to 650 nm at an angle of incidence<15°, and
wherein the quantity, thicknesses and materials of the plurality of alternating high index and low index layers of the outer layered film and the inner layered film are configured so that the window exhibits a transmittance of greater than 99% for the infrared wavelength of 1550 nm±25 nm at normal incidence.

2. The window according to claim 1, wherein a low index layer in the outer layered film and the inner layered film is in contact with the outer and inner primary surfaces of the substrate, respectively.

3. (canceled)

4. The window according to claim 1, wherein each of the low index layers comprises a silicon-containing oxide.

5. The window according to claim 1, wherein the plurality of alternating high index and low index layers in at least one of the inner layered film and the outer layered film is from five (5) to fifteen (15) layers.

6. (canceled)

7. (canceled)

8. The window according to claim 1, wherein the scratch resistant layer has a thickness from 1 μm to 10 μm, and the outer layered film exhibits a hardness of at least 14 GPa, as measured with a Berkovich Indenter Hardness Test from the outermost surface of the outer layered film to a depth of 1 μm.

9. A window for a sensing system, comprising:
a substrate comprising an outer primary surface and an inner primary surface, wherein the outer and inner primary surfaces are opposite of one another;
an outer layered film disposed on the outer primary surface of the substrate; and
an inner layered film disposed on the inner primary surface of the substrate,
wherein the outer layered film comprises a plurality of alternating high index and low index layers,
wherein the inner layered film comprises a plurality of alternating high index and low index layers,
wherein each of the high index layers having a refractive index greater than a refractive index of each of the low index layers,
wherein the outer layered film comprises a scratch resistant layer having a thickness from about 0.5 μm to about 10 μm,
wherein the inner layered film comprises one or more absorption layers, wherein each absorption layer comprises a refractive index of 3.0 or greater and an extinction coefficient of 0.1 or greater at one or more wavelengths in the ultraviolet and visible spectra from 100 nm to 700 nm,
wherein the outer layered film exhibits a hardness of at least 11 GPa, as measured with a Berkovich Indenter Hardness Test from the outermost surface of the outer layered film to a depth of 1 μm,
wherein the quantity, thicknesses and materials of the plurality of alternating high index and low index layers of the outer layered film and the inner layered film are configured so that the window exhibits an average transmittance of greater than 85% within 25 nm of at least one wavelength within the infrared spectrum from 900 nm to 1600 nm at an angle of incidence<15° and an average transmittance of less than 5% in the visible spectrum from 420 nm to 650 nm at an angle of incidence<15°, and
wherein the quantity, thicknesses and materials of the plurality of alternating high index and low index layers of the outer layered film and the inner layered film are configured so that the window exhibits a reflectance of less than 0.15% for the infrared wavelength of 1550 nm±25 nm at normal incidence.

10. The window according to claim 9, wherein the one or more absorption layers are selected from the group consisting of amorphous silicon (a-Si), germanium (Ge) and gallium arsenide (GaAs), and further wherein none of the one or more absorption layers are in direct contact with the inner primary surface of the substrate.

11. The window according to claim 9, wherein the one or more of the high index layers of the inner layered film are the one or more absorption layers.

12. The window according to claim 9, wherein the one or more absorption layers are amorphous silicon (a-Si).

13. The window according to claim 9, wherein the quantity, thicknesses and materials of the plurality of alternating high index and low index layers of the outer layered film and the inner layered film are configured so that the window exhibits a transmittance of less than 10% in the visible spectrum from 420 nm to 700 nm at normal incidence.

14. The window according to claim 9, wherein the plurality of alternating high index and low index layers in at least one of the inner layered film and the outer layered film is from five (5) to fifteen (15) layers.

15. (canceled)

16. (canceled)

17. A window for a sensing system, comprising:
a substrate comprising an outer primary surface and an inner primary surface, wherein the outer and inner primary surfaces are opposite of one another;
an outer layered film disposed on the outer primary surface of the substrate; and
an inner layered film disposed on the inner primary surface of the substrate,
wherein the outer layered film comprises a plurality of alternating high index and low index layers,
wherein the inner layered film comprises a plurality of alternating high index and low index layers,
wherein each of the high index layers having a refractive index greater than a refractive index of each of the low index layers,
wherein the outer layered film comprises a scratch resistant layer having a thickness from about 0.5 μm to about 10 μm,
wherein the inner layered film or the outer layered film comprises a transparent conductive oxide layer,
wherein the outer layered film exhibits a hardness of at least 11 GPa, as measured with a Berkovich Indenter Hardness Test from the outermost surface of the outer layered film to a depth of 1 μm, and
further wherein the quantity, thicknesses and materials of the plurality of alternating high index and low index layers of the outer layered film and the inner layered film are configured so that the window exhibits an average transmittance of greater than 85% within 25 nm of at least one wavelength within the infrared spectrum from 900 nm to 1600 nm at an angle of incidence<15° and an average transmittance of less than 5% in the visible spectrum from 420 nm to 650 nm at an angle of incidence<15°.

18. The window according to claim 17, wherein the transparent conductive oxide layer is positioned between the substrate and the scratch resistant layer in the outer layered film.

19. The window according to claim 17, wherein the transparent conductive oxide layer is positioned in the inner layered film between the substrate and one of the high or low index layers.

20. The window according to claim 17, wherein the quantity, thicknesses and materials of the plurality of alternating high index and low index layers of the outer layered film and the inner layered film are further configured so that the window exhibits an energy attenuation of at least 15 dB for microwave radiation of greater than 1 GHz.

21. The window according to claim 17, wherein a low index layer in the outer layered film is in contact with the outer primary surface of the substrate.

22. The window according to claim 17, wherein each of the high index layers comprises a silicon-containing nitride, a silicon-containing oxynitride, an aluminum-containing nitride or an aluminum-containing oxynitride.

23. The window according to claim 17, wherein each of the low index layers comprises a silicon-containing oxide.

24. (canceled)

25. (canceled)

26. The window according to claim 17, wherein at least one of the inner layered film and the outer layered film comprises one or more absorption layers, wherein each absorption layer comprises a refractive index of 3.0 or greater and an extinction coefficient of 0.1 or greater at one or more wavelengths in the ultraviolet and visible spectra from 100 nm to 700 nm.

27. (canceled)

28. The window according to claim 26, wherein the one or more of the high index layers of the inner layered film are the one or more absorption layers.
